(19) United States
(12) Patent Application Publication
(10) Pub. No.: US 2024/0319908 A1
(43) Pub. Date: Sep. 26, 2024

(54) RANDOM NUMBER GENERATION CIRCUIT AND MEMORY SYSTEM

(71) Applicant: Kioxia Corporation, Tokyo (JP)

(72) Inventors: Yousuke KINO, Yokohama Kanagawa (JP); Ryo NOGAMI, Sagamihara Kanagawa (JP); Atsushi TAKAYAMA, Yokohama Kanagawa (JP); Kenji SAKURADA, Yamato Kanagawa (JP); Naoto KUMANO, Yokohama Kanagawa (JP)

(21) Appl. No.: 18/590,789

(22) Filed: Feb. 28, 2024

(30) Foreign Application Priority Data
Mar. 22, 2023 (JP) 2023-045856
Sep. 15, 2023 (JP) 2023-150464

(51) Int. Cl. G06F 3/06; G06F 7/58

(52) U.S. Cl. CPC G06F 3/0655; G06F 3/0604; G06F 3/0679; G06F 7/58

(57) ABSTRACT

A memory circuit includes a plurality of storage areas each designated by one of a plurality of addresses. The control circuit stores a plurality of values, all of which are different from each other, in the plurality of storage areas, generates a first random number, obtains a first address that is one of the plurality of addresses using the first random number, reads a first value stored in a first storage area designated by the first address, and reads a second value stored in a second storage area designated by a second address. The second address is an address having the largest value among a range of addresses from which the first address can be obtained. The control circuit writes the second value into the first storage area after reading the first value therefrom. The control circuit outputs the first value as one value of an output random number.

### CROSS-REFERENCE TO RELATED APPLICATION(S)

This application is based upon and claims the benefit of priority from Japanese Patent Application No. 2023-045856, filed Mar. 22, 2023 and Japanese Patent Application No. 2023-150464, filed Sep. 15, 2023, the entire contents of both of which are incorporated herein by reference.

### FIELD

Embodiments described herein relate generally to a random number generation circuit.

### BACKGROUND

Random number generation circuits that randomly output non-overlapping values from a certain range of values are known.

### DESCRIPTION OF THE DRAWINGS

FIG. 1 is a block diagram illustrating a hardware configuration of a random number generation circuit according to a first embodiment.

FIG. 2 is a diagram illustrating a configuration of functional blocks of the random number generation circuit according to the first embodiment.

FIG. 3 is a diagram illustrating exchange of instructions and data between functional blocks of the random number generation circuit according to the first embodiment.

FIG. 4 is a flowchart illustrating an operation of the random number generation circuit according to the first embodiment.

FIG. 5 is a diagram illustrating an initial storage state of a memory circuit in the random number generation circuit according to the first embodiment.

FIG. 6 is a diagram illustrating a specific example of the transition of a storage state of the memory circuit in the random number generation circuit according to the first embodiment.

FIG. 7 is a flowchart illustrating an operation of a random number generation circuit according to a second embodiment.

FIG. 8 is a diagram illustrating an initial storage state of a memory circuit in the random number generation circuit according to the second embodiment.

FIG. 9 is a diagram illustrating a specific example of the transition of a storage state of the memory circuit in the random number generation circuit according to the second embodiment.

FIG. 10 is a flowchart illustrating an operation of a random number generation circuit according to a third embodiment.

FIG. 11 is a diagram illustrating a state in which part of the operation according to the third embodiment is pipelined.

FIG. 12 is a flowchart illustrating an operation of a random number generation circuit according to a fourth embodiment.

FIG. 13 is a diagram illustrating a specific example of the transition of a storage state of a memory circuit in the random number generation circuit according to the fourth embodiment.

FIG. 14 is a diagram illustrating a specific example of the transition of the storage state of the memory circuit in the random number generation circuit according to the fourth embodiment.

FIGS. 15-31 are diagrams illustrating a specific example of transition of addresses, storage values, and variables in the memory circuit in the random number generation circuit according to the fourth embodiment.

FIG. 32 is a flowchart illustrating an operation of a random number generation circuit according to a modification of the fourth embodiment.

FIG. 33 is a diagram illustrating a specific example of the transition of the storage state of the memory circuit in the random number generation circuit according to the modification of the fourth embodiment.

FIG. 34 is a flowchart illustrating an operation of a random number generation circuit according to a fifth embodiment.

FIG. 35 is a diagram illustrating a storage state of a memory circuit in the random number generation circuit according to the fifth embodiment.

FIG. 36 is a flowchart illustrating an operation of a random number generation circuit according to a sixth embodiment.

FIGS. 37-39 are diagrams illustrating a specific example of the transition of a storage state of the memory circuit in the random number generation circuit according to the sixth embodiment.

### DETAILED DESCRIPTION

Embodiments provide a random number generation circuit that can randomly and efficiently output non-overlapping values from a certain range of values.

In general, according to one embodiment, a random number generation circuit includes a memory circuit and a control circuit. The memory circuit includes a plurality of storage areas each designated by one of a plurality of addresses. The control circuit is configured to store a plurality of values, all of which are different from each other, in the plurality of storage areas, to generate a first random number, to obtain a first address that is one of the plurality of addresses using the first random number, to read out a first value stored in a first storage area designated by the first address, and to read out a second value stored in a second storage area designated by a second address among the plurality of storage areas. The second address is an address having the largest value among a range of addresses from which the first address can be obtained. The control circuit is configured to write the second value in the first storage area after reading the first value therefrom, and output the first value as one value of an output random number.

Hereinafter, embodiments will be described with reference to the drawings. In the following description, common reference numerals are given to components having the same function and configuration. In addition, the embodiments described below exemplifies a device and method for embodying the technical idea of the present embodiment, and the materials, shapes, structures, arrangement, and the like of the component parts are not limited to the ones shown below.

Functional blocks may be implemented as hardware, computer software, or a combination of both. It is not essential that the functional blocks be differentiated as in the example below. For example, some functions may be executed by functional blocks other than the illustrated functional blocks. Furthermore, the example functional blocks may be divided into finer functional sub-blocks.

### 1. FIRST EMBODIMENT

A random number generation circuit according to a first embodiment will be described. The random number generation circuit of the first embodiment is a circuit that uses random numbers generated by a random number generator to randomly output any values from a certain range of values without duplication.

### 1.1 Configuration of First Embodiment

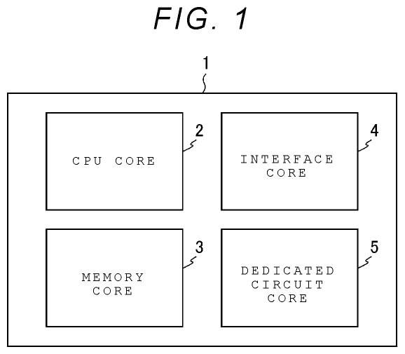

An example of a hardware configuration of the random number generation circuit of the first embodiment will be described. FIG. 1 is a block diagram illustrating the hardware configuration of the random number generation circuit of the first embodiment.

The random number generation circuit 1 is configured with, for example, a semiconductor device such as a system-on-a-chip (SoC). Specifically, the random number generation circuit 1 includes a central processing unit (CPU) core (or processor core) 2, a memory core 3, an interface core 4, and a dedicated circuit core 5. The CPU core 2 performs arithmetic processing, data processing, and various controls. The memory core 3 includes a memory element that stores software and data, and a circuit that controls the memory element. The interface core 4 is a circuit that inputs and outputs control signals and data between an external device and the random number generation circuit 1, and controls these inputs and outputs. The dedicated circuit core 5 includes a plurality of dedicated circuits having various functions described below.

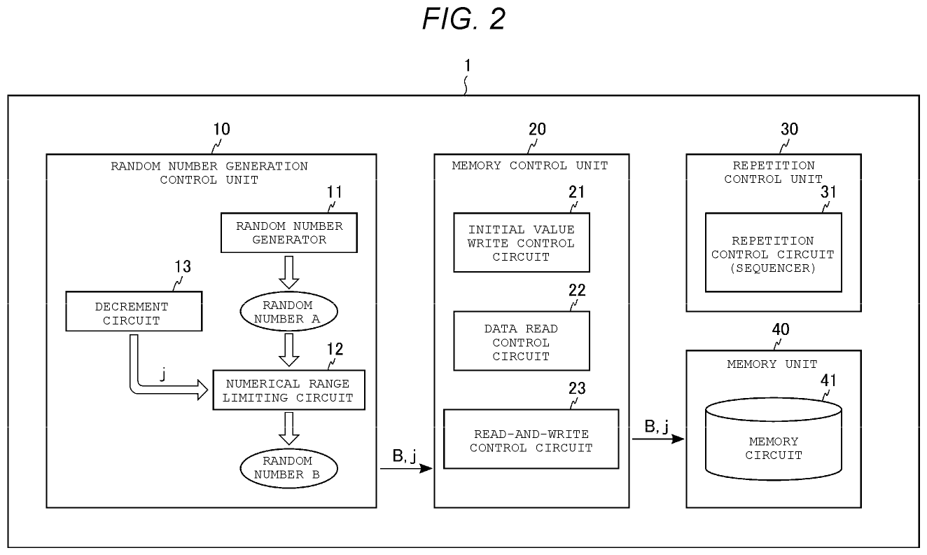

Next, a configuration of the functional blocks of the random number generation circuit of the first embodiment will be described. FIG. 2 is a diagram illustrating the configuration of the functional blocks in the random number generation circuit of the first embodiment.

The random number generation circuit 1 includes a random number generation control unit 10, a memory control unit 20, a repetition control unit 30, and a memory unit 40.

The random number generation control unit 10 includes a random number generator 11, a numerical range limiting circuit 12, and a decrement circuit 13. The random number generator 11 generates and outputs a random number A. The random number A is any integer. The random number generator 11 is, for example, a random number generating circuit such as a Mersenne twister. The numerical range limiting circuit 12 performs processing to limit the random number A to values in the range of 0, 1, 2, . . . , j. The decrement circuit 13 decrements a variable “j”. That is, the decrement circuit 13 subtracts 1 from the variable “j”. The variable “j” is an integer greater than or equal to 1.

The memory control unit 20 includes an initial value write control circuit 21, a data read control circuit 22, and a read-and-write control circuit 23. The initial value write control circuit 21 writes (Y+1) different values into the memory unit 40. The (Y+1) different values may be any value. For example, the (Y+1) values are consecutive integer values. The minimum value of these consecutive integers is, for example, 0. The maximum value of these consecutive integers is, for example, Y. The initial value write control circuit 21 may obtain (Y+1) values from outside the random number generation circuit 1 (for example, a nonvolatile memory to which the random number generation circuit 1 is connected).

The data read control circuit 22 reads data stored in the storage area of the memory unit 40 designated by an address B. The read-and-write control circuit 23 reads data stored in the storage area of the memory unit 40 designated by an address j, and writes the read data to the storage area designated by the address B. B is an integer greater than or equal to 0 and smaller than or equal to j. Hereinafter, accessing the storage area designated by an address Z of the memory unit 40 (that is, reading data from this storage area or writing data to this storage area) will be also referred to as accessing the address Z.

The memory unit 40 includes a memory circuit 41. The memory circuit 41 stores data in a storage area designated by an address. The memory circuit 41 includes, for example, an SRAM (static random access memory).

The repetition control unit 30 includes a repetition control circuit 31. The repetition control circuit 31 controls circuits in the random number generation control unit 10, the memory control unit 20, and the memory unit 40. The repetition control circuit 31 includes, for example, a sequencer.

The random number generation control unit 10 is configured using, for example, the dedicated circuit core 5 or the CPU core 2. The memory control unit 20 is configured using, for example, the dedicated circuit core 5 or the CPU core 2. The repetition control unit 30 is configured using the CPU core 2, for example. The memory unit 40 is configured using the memory core 3, for example.

### 1.2 Operation of First Embodiment

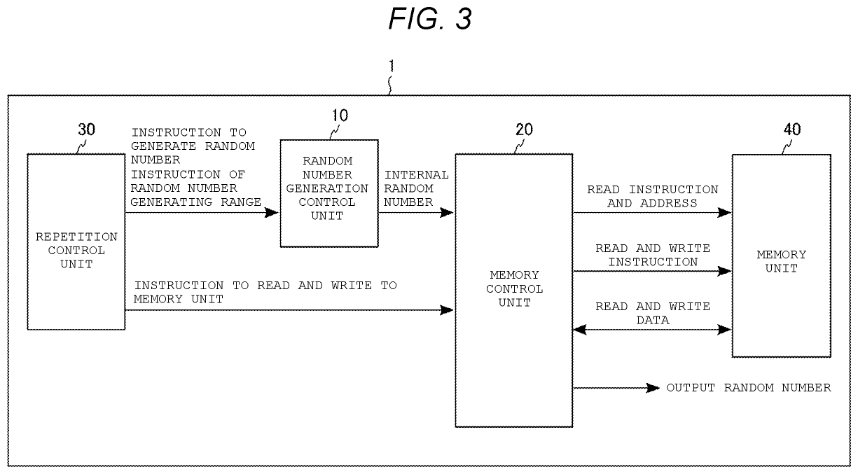

The random number generation circuit according to the first embodiment will be described. First, exchange of instructions and data between functional blocks in the random number generation circuit 1 will be described using FIG. 3. FIG. 3 is a diagram illustrating exchange of instructions and data between functional blocks of the random number generation circuit according to the first embodiment.

First, at the timing of starting the operation, the repetition control unit 30 transmits an instruction for random number generation and an instruction for a random number generation range to the random number generation control unit 10.

The random number generation control unit 10 generates random numbers based on the instruction for random number generation and the instruction for random number generation range. The random number generation control unit 10 transmits the generated random number to the memory control unit 20. Hereinafter, the random number generated by the random number generation control unit 10 will also be referred to as an internal random number. Further, the repetition control unit 30 transmits, to the memory control unit 20, instructions for read operations and write operations to the memory unit 40.

The memory control unit 20 transmits the instruction for read operation and an address to the memory unit 40. At this time, the memory control unit 20 transmits a value based on the internal random number received from the random number generation control unit 10 as the address. The memory unit 40 reads data stored in a storage area designated by the address based on the instruction for read operation and the address. Further, the memory unit 40 transmits the read data to the memory control unit 20. The memory control unit 20 outputs the received data. As will be described later, the data output from the memory control unit 20 is a value obtained from different values based on the internal random number. Hereinafter, the data output from the memory control unit 20 will also be referred to as an output random number.

The memory control unit 20 also transmits the instructions for read operations and write operations to the memory unit 40. The memory unit 40 performs read operations and write operations based on the instructions. Further, the memory unit 40 transmits the read data to the memory control unit 20 and receives write data from the memory control unit 20.

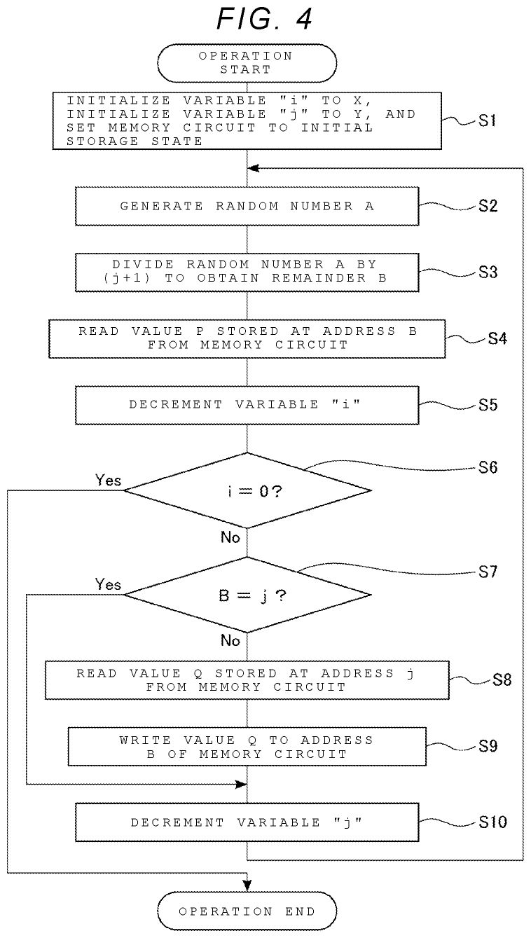

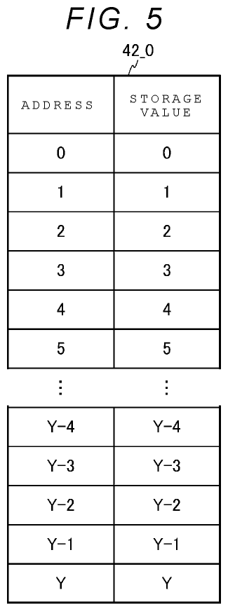

Next, an operation of the random number generation circuit of the first embodiment will be described. FIG. 4 is a flowchart illustrating the operation of the random number generation circuit of the first embodiment. The operations illustrated in this flowchart are controlled by the repetition control circuit (or sequencer) 31. FIG. 5 illustrates an initial storage state of the memory circuit 41. FIG. 5 illustrates addresses of the memory circuit 41 and data (storage values) stored in these addresses.

In the operation of the first embodiment, the random number generation circuit 1 randomly obtains X non-overlapping values from among (Y+1) values. Here, Y is an integer greater than or equal to 1. X is an integer greater than or equal to 1 and smaller than or equal to Y. Here, a case will be described in which the initial value write control circuit 21 writes consecutive integer values (0 to Y) into the memory unit 40 as (Y+1) different values.

As illustrated in FIG. 4, first, the repetition control circuit 31 sets a variable “i” to X. The variable “i” is a variable for managing the number of obtained output random numbers. The variable “i” is an integer smaller than or equal to X. Further, the repetition control circuit 31 sets the variable “j” to Y. The variable “j” is a variable that indicates the maximum value among the values of addresses of the memory circuit 41 from which output random numbers have not been read. The variable “j” is an integer smaller than or equal to Y. Further, the repetition control circuit 31 sets the memory circuit 41 to an initial storage state 420 using the initial value write control circuit 21 (S1). As illustrated in FIG. 5, when the memory circuit 41 is in the initial storage state 420, storage values 0, 1, 2, 3, . . . , Y−4, Y−3, Y−2, Y−1, and Y are stored in addresses 0, 1, 2, 3, . . . , Y−4, Y−3, Y−2, Y−1, and Y, respectively.

Next, the repetition control circuit 31 generates a random number (i.e., internal random number) A using the random number generator 11 (S2). The internal random number A is any integer.

Subsequently, the repetition control circuit 31 causes the numerical range limiting circuit 12 to perform processing to limit the internal random number A to values in the range of 0 to j. That is, the numerical range limiting circuit 12 performs processing to obtain a value in the range of 0 to j using the internal random number A. Specifically, the numerical range limiting circuit 12 divides the internal random number A by (j+1). The numerical range limiting circuit 12 calculates the remainder B by this division (S3). The remainder B is an integer greater than or equal to 0 and smaller than or equal to j. It is noted that, as described above, the initial value of the variable “j” is equal to Y. In this case, the remainder B is an integer greater than or equal to 0 and smaller than or equal to Y.

Next, the repetition control circuit 31 regards the remainder B as an address of the memory circuit 41 and reads a value P from the address B of the memory circuit 41 using the data read control circuit 22 (S4). The value P is an integer greater than or equal to 0 and smaller than or equal to Y. This value P is the output random number P output from the memory control unit 20.

Next, the repetition control circuit 31 decrements the variable “i”. That is, the repetition control circuit 31 subtracts 1 from the variable “i” (S5).

Subsequently, the repetition control circuit 31 determines whether the variable “i” after the subtraction is 0 (S6). If the variable “i” is 0 (Yes in S6), the repetition control circuit 31 ends the operation since the output random number P has been obtained X times.

If the variable “i” is not 0 (No in S6), the repetition control circuit 31 determines whether the remainder B (that is, the address B) and the variable “j” are equal (S7). That is, the repetition control circuit 31 determines whether the value of the address of the memory circuit 41 from which the output random number was read in step S4 is the maximum value among the values of the addresses from which the output random number has not been read so far. If the remainder B and the variable “j” are equal (Yes in S7), the repetition control circuit 31 skips steps S8 and S9 and decrements the variable “j” using the decrement circuit 13 since the maximum value among the values of the addresses from which the output random number has not yet been read is the remainder B (S10). That is, the repetition control circuit 31 subtracts 1 from the variable “j”. Thereafter, the repetition control circuit 31 repeats the processing from step S2 onwards.

If the remainder B and the variable “j” are not equal (No in S7), the repetition control circuit 31 causes the read-and-write control circuit 23 to read out a value Q stored in the storage area of the memory circuit 41 indicated by the address of the value of the variable “j” (S8). The value Q is an integer greater than or equal to 0 and smaller than or equal to Y.

Next, the repetition control circuit 31 writes the value Q to the address B of the memory circuit 41 using the read-and-write control circuit 23 (S9). That is, the repetition control circuit 31 overwrites the address B from which the value P was read in step S4 with the value Q read from the address j.

Next, the process by the repetition control circuit 31 moves to step S10. As described above, the repetition control circuit 31 decrements the variable “j” using the decrement circuit 13. Thereafter, the repetition control circuit 31 repeats the processing from step S2 onwards.

By repeating steps S2 to S10 described above, the random number generation circuit 1 obtains X output random numbers P that do not overlap among the (Y+1) values.

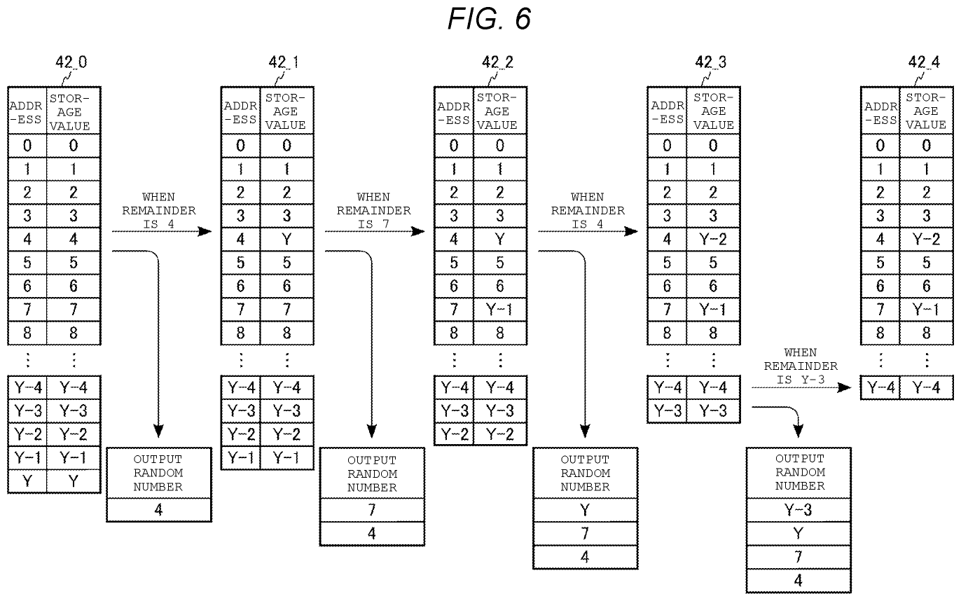

A specific operation of the random number generation circuit of the first embodiment will be described below with reference to FIGS. 5 and 6. FIG. 6 illustrates the specific example of the transition of the storage state of the memory circuit 41.

In step S1 of FIG. 4, the memory circuit 41 is set to the initial storage state 420, as illustrated in FIG. 5. That is, when the memory circuit 41 is in the initial storage state 42_0, the storage values 0, 1, 2, 3, . . . , Y−4, Y−3, Y−2, Y−1, and Y are stored in the addresses 0, 1, 2, 3, . . . , Y−4, Y−3, Y−2, Y−1, and Y, respectively.

As illustrated in FIG. 6, it is assumed that 4 is obtained as the remainder B in the first random number obtaining operation (step S3 in FIG. 4). Then, the value 4 stored at the address 4 is read out (step S4 in FIG. 4). Then, the read value 4 is obtained as an output random number. Thereafter, the value Y read from address j is written to address 4 (steps S8 to S9 in FIG. 4). As described above, the variable “j” is equal to Y during the first random number obtaining operation. Furthermore, the variable “j” is decremented, and the range of addresses for which no output random numbers have been obtained becomes 0 to (Y−1). As a result, in the storage state 42_1 of the memory circuit 41, the storage values 0, 1, 2, 3, Y, 5, 6, 7, 8, . . . , Y−4, Y−3, Y−2, and Y−1 are stored in the addresses 0, 1, 2, 3, 4, 5, 6, 7, 8, . . . , Y−4, Y−3, Y−2, and Y−1, respectively. It is noted that the state of the address Y in the storage state 42_1 is omitted in FIG. 6.

Next, it is assumed that 7 is obtained as the remainder B in the second random number obtaining operation (step S3 in FIG. 4). Then, the value 7 stored at the address 7 is read out (step S4 in FIG. 4). Then, the read value 7 is obtained as an output random number. Thereafter, the value (Y−1) read from the address j (i.e., address (Y−1)) is written to the address 7 (steps S8 to S9 in FIG. 4). Furthermore, the variable “j” is decremented from (Y−1) to (Y−2), and the range of addresses for which no output random numbers have been obtained becomes 0 to (Y−2). As a result, in the storage state 42_2 of the memory circuit 41, the storage values 0, 1, 2, 3, Y, 5, 6, Y−1, 8, . . . , Y−4, Y−3, and Y−2 are stored in the addresses 0, 1, 2, 3, 4, 5, 6, 7, 8, . . . , Y−4, Y−3, and Y−2, respectively. It is noted that the states of the address (Y−1) to the address Y in the storage state 42_2 are omitted in FIG. 6.

Further, it is assumed that 4 is obtained as the remainder B in the third random number obtaining operation (step S3 in FIG. 4). Then, the value Y stored at the address 4 is read out (step S4 in FIG. 4). Then, the read value Y is obtained as an output random number. Thereafter, the value (Y−2) read from the address j (i.e., address (Y−2)) is written to the address 4 (steps S8 to S9 in FIG. 4). Furthermore, the variable “j” is decremented from (Y−2) to (Y−3), and the range of addresses for which no output random numbers have been obtained becomes 0 to (Y−3). As a result, in the storage state 42_3 of the memory circuit 41, the storage values 0, 1, 2, 3, Y−2, 5, 6, Y−1, 8, . . . , Y−4, and Y−3 are stored in the addresses 0, 1, 2, 3, 4, 5, 6, 7, 8, . . . , Y−4, and Y−3, respectively. It is noted that the states of the address (Y−2) to the address Y in the storage state 42_3 are omitted in FIG. 6.

Further, it is assumed that (Y−3) is obtained as the remainder B in the fourth random number obtaining operation (step S3 in FIG. 4). Then, the value (Y−3) stored at the address (Y−3) is read out (step S4 in FIG. 4). Then, the read value (Y−3) is obtained as an output random number. Furthermore, the variable “j” is decremented from (Y−3) to (Y−4), and the range of addresses for which no output random numbers have been obtained becomes 0 to (Y−4). As a result, in the storage state 42_4 of the memory circuit 41, the storage values 0, 1, 2, 3, Y−2, 5, 6, Y−1, 8, . . . , and Y−4 are stored in the addresses 0, 1, 2, 3, 4, 5, 6, 7, 8, . . . , and Y−4, respectively. It is noted that the states of the address (Y−3) to the address Y in the storage state 42_4 are omitted in FIG. 6.

By repeating the random number obtaining operation described above X times, the random number generation circuit 1 can obtain X output random numbers that do not overlap from among (Y+1) values.

### 1.3 Effects of First Embodiment

According to the first embodiment, it is possible to provide a random number generation circuit that can randomly and efficiently output non-overlapping values from a certain range of values.

In the first embodiment, the random number B generated by the random number generation control unit 10 is used as an address for reading data from the memory circuit 41 of the memory unit 40. The memory circuit 41 stores non-overlapping values 0 to Y. The memory control unit 20 outputs the value P read from the address B as a random number. Every time data stored at the address B is read, the address B is overwritten with a value read from an address that has not been read yet in the memory circuit 41. Then, the range of the next random number to be obtained is decremented. That is, the value stored at an address that has been read once is overwritten with the value stored at an address that has not yet been read, and the range from which random numbers can be obtained is reduced. As a result, thereafter, even if the random number B (i.e., address B) generated by the random number generation control unit 10 overlaps with the previous values, the value P read from the memory circuit 41 will not overlap with the previously read values.

Further, in the first embodiment, after the value P stored at the address B is read from the memory circuit 41, the value stored at the address B is rewritten so that the read values do not overlap. This rewriting needs to be done only once for each random number output. Therefore, the number of times the value stored in the memory circuit 41 is rewritten can be minimized to the minimum number of times, and the number of times the value is rewritten in the memory circuit 41 can be reduced.

Therefore, in the configuration of the first embodiment, since the number of times values are rewritten in the memory circuit 41 can be reduced, the operation of obtaining X random numbers can be sped up. In other words, the time required for the operation of obtaining X random numbers can be reduced.

Furthermore, since the number of times values are rewritten in the memory circuit 41 can be reduced, power consumption related to the operation of obtaining X random numbers can be reduced.

As described above, according to the first embodiment, it is possible to provide a random number generation circuit that can efficiently output random numbers.

An example in which the random number generation circuit of the first embodiment is applied to error emulation of a nonvolatile memory will be described below. The nonvolatile memory is, for example, a NAND flash memory.

A semiconductor device including the random number generation circuit 1 can function as a memory controller that controls the nonvolatile memory. The semiconductor device, which functions as the memory controller, and the nonvolatile memory comprise a memory system. The memory controller is electrically connected to the nonvolatile memory. The memory controller may use the random number generation circuit 1 to execute error emulation of the nonvolatile memory.

In the error emulation, for example, error data is randomly inserted into data read from the nonvolatile memory (read data). This error emulation is used, for example, to evaluate the error correction ability of the memory controller. For example, the memory controller reads read data from the nonvolatile memory. When determining 500 positions of error data from 4000 candidate positions in the read data, the memory controller uses the random number generation circuit 1 of the first embodiment to randomly obtain 500 non-overlapping values (i.e., X=500) from 4000 integers (that is, Y=3999). The memory controller determines the 500 positions of the error data based on the obtained non-overlapping values. The memory controller inserts an error at the determined position. The memory controller then executes error correction on the read data including the inserted errors.

In this case, the random number generation circuit 1 can execute this operation by simply rewriting 500 times data stored in the memory circuit 41. That is, by using the random number generation circuit 1 of the first embodiment for error emulation, it is possible to reduce the number of times of data rewriting in the memory circuit 41 required in the above operation.

### 2. SECOND EMBODIMENT

A random number generation circuit according to a second embodiment will be described. The random number generation circuit of the second embodiment is a circuit that uses random numbers generated by a random number generator to randomly output all values from a certain range of values without duplication. In the second embodiment, differences from the first embodiment will be mainly described.

### 2.1 Configuration of Second Embodiment

The hardware configuration and functional block configuration of the random number generation circuit of the second embodiment are the same as those of the first embodiment described above.

### 2.2 Operation of Second Embodiment

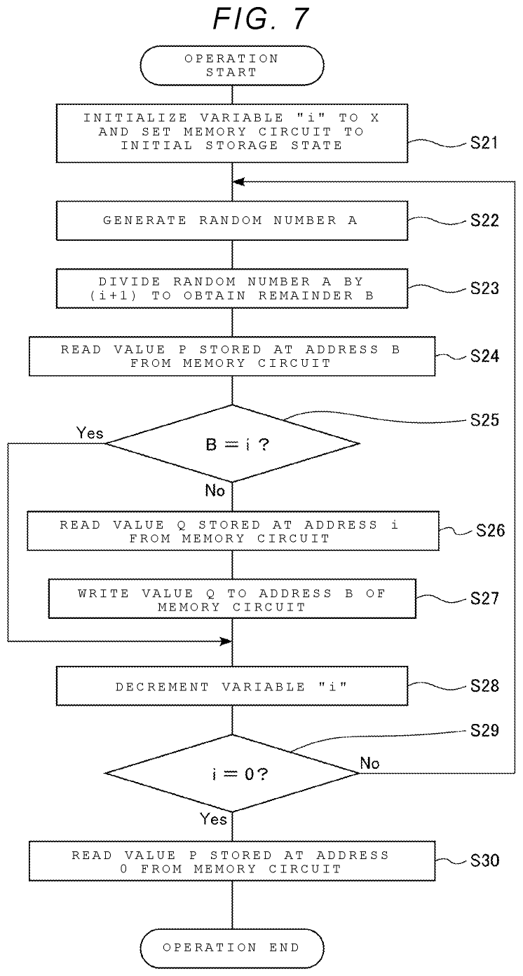

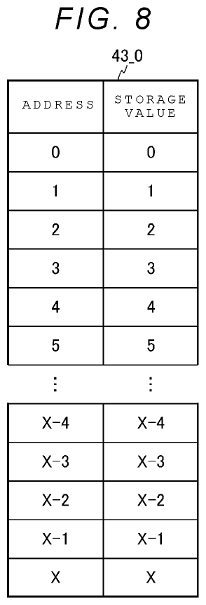

An operation of the random number generation circuit according to the second embodiment will be described. FIG. 7 is a flowchart illustrating the operation of the random number generation circuit of the second embodiment. The processing illustrated in this flowchart is controlled by the repetition control circuit (or sequencer) 31. FIG. 8 illustrates an initial storage state of the memory circuit 41. FIG. 8 illustrates addresses of the memory circuit 41 and data (storage values) stored in these addresses.

In the operation of the second embodiment, the random number generation circuit 1 randomly obtains (X+1) non-overlapping values. Here, X is an integer greater than or equal to 1. It is noted that the second embodiment corresponds to the case where X is (Y+1) in the first embodiment.

As illustrated in FIG. 7, first, the repetition control circuit 31 sets the variable “i” to X. Further, the repetition control circuit 31 sets the memory circuit 41 to an initial storage state 43_0 using the initial value write control circuit 21 (S21). As shown in FIG. 8, when the memory circuit 41 is in the initial storage state 43_0, the storage values 0, 1, 2, 3, . . . , X−4, X−3, X−2, X−1, and X are stored at addresses 0, 1, 2, 3, . . . , X−4, X−3, X−2, X−1, and X, respectively.

Next, the repetition control circuit 31 generates an internal random number A using the random number generator 11 (S22). The internal random number A is any integer.

Subsequently, the repetition control circuit 31 causes the numerical range limiting circuit 12 to perform processing to limit the internal random number A to values in the range of 0 to i. That is, the numerical range limiting circuit 12 performs processing to obtain a value in the range of 0 to i using the internal random number A. Specifically, the numerical range limiting circuit 12 divides the internal random number A by (i+1). The numerical range limiting circuit 12 calculates the remainder B by this division (S23).

Next, the repetition control circuit 31 regards the remainder B as an address of the memory circuit 41 and reads the value P from the address B of the memory circuit 41 using the data read control circuit 22 (S24).

Next, the repetition control circuit 31 determines whether the remainder B and the variable “i” are equal (S25). If the remainder B and the variable “i” are not equal (No in S25), the repetition control circuit 31 causes the read-and-write control circuit 23 to read out the value Q stored in the storage area of the memory circuit 41 indicated by the address of the value of the variable “i” (S26).

Next, the repetition control circuit 31 writes the value Q to the address B of the memory circuit 41 using the read-and-write control circuit 23 (S27). That is, the repetition control circuit 31 overwrites the address B from which the value P was read in step S24 with the value Q read from the address i. Thereafter, the process by the repetition control circuit 31 moves to step S28.

On the other hand, if the remainder B and the variable “i” are equal (Yes in S25), since the maximum value among the values of the addresses from which the output random number has not yet been read is the remainder B, steps S26 and S27 are skipped and the processing by the repetition control circuit 31 moves to step S28.

The repetition control circuit 31 decrements the variable “i” using the decrement circuit 13 (S28). That is, the repetition control circuit 31 subtracts 1 from the variable “i”.

Next, the repetition control circuit 31 determines whether the variable “i” after the subtraction is 0 (S29). If the variable “i” is not 0 (No in S29), the repetition control circuit 31 repeats the processes from step S22 onwards.

On the other hand, if the variable “i” is 0 (Yes in S29), the repetition control circuit 31 reads out the value P stored at the address 0 using the data read control circuit 22 (S30). Thereafter, the repetition control circuit 31 ends the operation.

By repeating steps S22 to S30 described above, the random number generation circuit 1 obtains (X+1) output random numbers P that do not overlap among the (X+1) values.

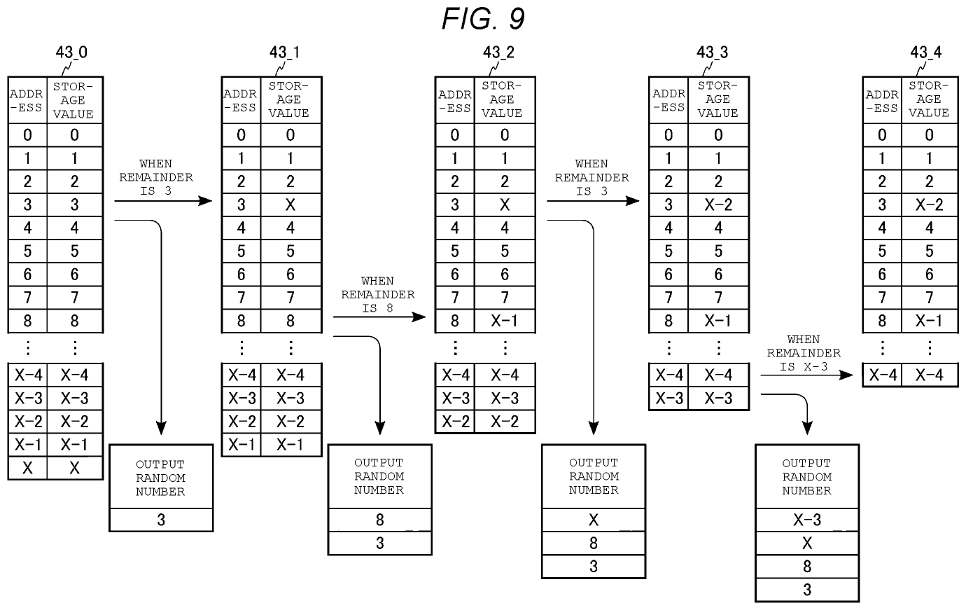

A specific operation of the random number generation circuit of the second embodiment will be described below with reference to FIGS. 8 and 9. FIG. 9 illustrates a specific example of the transition of the storage state of the memory circuit 41 according to the operation of the second embodiment.

In step S21 of FIG. 7, the memory circuit 41 is set to the initial storage state 43_0, as illustrated in FIG. 8. That is, when the memory circuit 41 is in the initial storage state 43_0, the storage values 0, 1, 2, 3, . . . , X−4, X−3, X−2, X−1, and X are stored at addresses 0, 1, 2, 3, . . . , X−4, X−3, X−2, X−1, and X, respectively.

As illustrated in FIG. 9, it is assumed that 3 is obtained as the remainder B in the first random number obtaining operation (step S23 in FIG. 7). Then, the value 3 stored at the address 3 is read out (step S24 in FIG. 7). Then, the read value 3 is obtained as an output random number. Thereafter, the value X read from the address i is written to the address 3 (steps S26 to S27 in FIG. 7). As described above, the variable “i” is equal to X during the first random number obtaining operation. Furthermore, the variable “i” is decremented, and the range of addresses for which no output random numbers have been obtained becomes 0 to (X−1). As a result, in the storage state 43_1 of the memory circuit 41, the storage values 0, 1, 2, X, 4, 5, 6, 7, 8, . . . , X−4, X−3, X−2, and X−1 are stored in the addresses 0, 1, 2, 3, 4, 5, 6, 7, 8, . . . , X−4, X−3, X−2, and X−1, respectively. It is noted that the state of the address X in the storage state 43_1 is omitted in FIG. 9.

Next, it is assumed that 8 is obtained as the remainder B in the second random number obtaining operation (step S23 in FIG. 7). Then, the value 8 stored at the address 8 is read out (step S24 in FIG. 7). Then, the read value 8 is obtained as an output random number. Thereafter, the value (X−1) read from the address i (i.e., address (X−1)) is written to the address 8 (steps S26 to S27 in FIG. 7). Furthermore, the variable “i” is decremented from (X−1) to (X−2), and the range of addresses for which no output random numbers have been obtained becomes 0 to (X−2). As a result, in the storage state 43_2 of the memory circuit 41, the storage values 0, 1, 2, X, 4, 5, 6, 7, X−1, . . . , X−4, X−3, and X−2 are stored in the addresses 0, 1, 2, 3, 4, 5, 6, 7, 8, . . . , X−4, X−3, and X−2, respectively. It is noted that the states of the address (X−1) to the address X in the storage state 43_2 are omitted in FIG. 9.

Further, it is assumed that 3 is obtained as the remainder B in the third random number obtaining operation (step S23 in FIG. 7). Then, the value X stored at the address 3 is read out (step S24 in FIG. 7). Then, the read value X is obtained as an output random number. Thereafter, the value (X−2) read from the address i (i.e., address (X−2)) is written to the address 3 (steps S26 to S27 in FIG. 7). Furthermore, the variable “i” is decremented from (X−2) to (X−3), and the range of addresses for which no output random numbers have been obtained becomes 0 to (X−3). As a result, in the storage state 43_3 of the memory circuit 41, the storage values 0, 1, 2, X−2, 4, 5, 6, 7, X−1, . . . , X−4, and X−3 are stored in the addresses 0, 1, 2, 3, 4, 5, 6, 7, 8, . . . , X−4, and X−3, respectively. It is noted that the states of the address (X−2) to the address X in the storage state 43_3 are omitted in FIG. 9.

Further, it is assumed that (X−3) is obtained as the remainder B in the fourth random number obtaining operation (step S23 in FIG. 7). Then, the value (X−3) stored at the address (X−3) is read out (step S24 in FIG. 7). Then, the read value (X−3) is obtained as an output random number. Thereafter, the variable “i” is decremented from (X−3) to (X−4), and the range of addresses for which no output random numbers have been obtained becomes 0 to (X−4). As a result, in the storage state 43_4 of the memory circuit 41, the storage values 0, 1, 2, X−2, 4, 5, 6, 7, X−1, . . . , and X−4 are stored in the addresses 0, 1, 2, 3, 4, 5, 6, 7, 8, . . . , and X−4, respectively. It is noted that the states of the address (X−3) to the address X in the storage state 43_4 are omitted in FIG. 9.

By repeating the random number obtaining operation described above (X+1) times, the random number generation circuit 1 can obtain (X+1) output random numbers that do not overlap from among (X+1) values.

### 2.3 Effects of Second Embodiment

According to the second embodiment, it is possible to provide a random number generation circuit that can randomly and efficiently output non-overlapping values from a certain range of values.

In the configuration of the second embodiment, all values can be randomly output from (X+1) values that do not overlap with each other. Therefore, with the configuration of the second embodiment, it is possible to achieve a shuffle circuit (or rearrangement circuit) that randomly extracts all values in a certain range. Other effects are similar to those of the first embodiment described above.

### 3. THIRD EMBODIMENT

A random number generation circuit according to a third embodiment will be described. The third embodiment illustrates an example in which some of the operations described in the first embodiment are executed in parallel. In the third embodiment, differences from the first embodiment will be mainly described.

### 3.1 Configuration of Third Embodiment

The hardware configuration and functional block configuration of the random number generation circuit of the third embodiment are the same as those of the first embodiment described above.

### 3.2 Operation of Third Embodiment

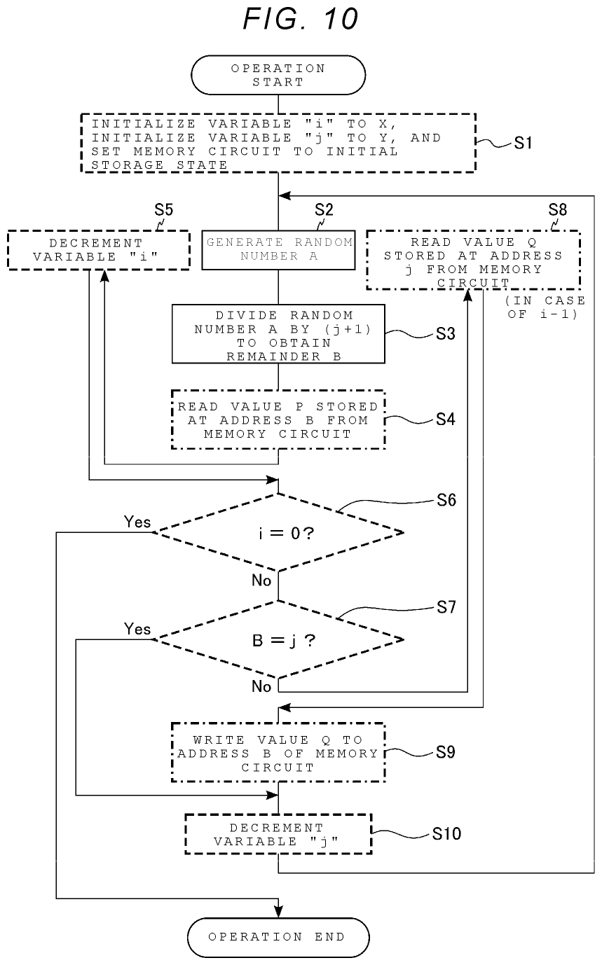

The random number generation circuit according to the third embodiment will be described. FIG. 10 is a flowchart illustrating the operation of the random number generation circuit of the third embodiment.

In the operation of obtaining X output random numbers P, the operations from the process of generating the internal random number A (S2) to the process of decrementing the variable “j” (S10) are repeatedly executed X times.

Among the processes that are repeatedly executed X times, as illustrated in FIG. 10, the process of generating the internal random number A (S2) and the process of calculating the remainder B (S3), the process of decrementing the variable “i” (S5), and the process of reading the value Q (S8) can be executed in parallel.

For example, the process of decrementing the variable “i” (S5) and the process of reading the value Q (S8) in the first output random number obtaining operation, and the process of generating the internal random number A in the second output random number obtaining operation (S2) can be executed in parallel. That is, the process of generating the internal random number A (S2) in the second output random number obtaining operation can be executed in parallel with the process of decrementing the variable “i” (S5) and the process of reading the value Q (S8) in the first output random number obtaining operation.

The process of generating the internal random number A (S2) is performed by the random number generator 11 in the random number generation control unit 10. The process of calculating the remainder B (S3) is performed by the numerical range limiting circuit 12. The process of decrementing the variable “i” (S5) is performed by the repetition control circuit 31 in the repetition control unit 30. Further, the process of reading the value Q (S8) is performed by the read-and-write control circuit 23 in the memory control unit 20.

Since a plurality of dedicated hardware circuits generally can operate in parallel, when at least two of these processes are executed by a dedicated hardware circuit, at least two of the process of generating the internal random number (S2) (or the process of calculating the remainder (S3)), the process of decrementing the variable “i” (S5), and the process of reading the value Q (S8) can be executed in parallel.

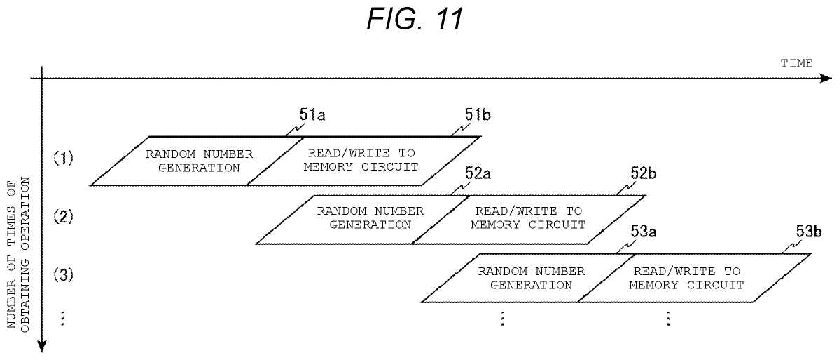

FIG. 11 is a diagram illustrating a state in which part of the operation according to the third embodiment is pipelined.

In the operation of obtaining X output random numbers P, the random number generation process (S2 and S3), the read process (S8), and the write process (S9) are repeatedly executed X times. The random number generation process (S2 and S3) includes the process of generating the internal random number A (S2) and the process of calculating the remainder B (S3). The read process and write process (S8 and S9) include the process of reading the value Q from the memory circuit 41 (S8) and the process of writing the value Q (S9).

As illustrated in FIG. 11, for example, in the operation of obtaining the first output random number, a random number generation process 51a illustrated in (1) is executed, and then a read-and-write process 51b is executed. In the operation of obtaining the second output random number, a random number generation process 52a illustrated in (2) is executed, and then a read-and-write process 52b is executed. Furthermore, in the operation of obtaining the third output random number, a random number generation process 53a illustrated in (3) is executed, and then a read-and-write process 53b is executed.

The random number generation processes 51a, 52a, and 53a are executed by the random number generator 11 and the numerical range limiting circuit 12. The read-and-write processes 51b, 52b, and 53b are executed by the read-and-write control circuit 23. When the random number generator 11, the numerical range limiting circuit 12, and the read-and-write control circuit 23 are each formed of dedicated hardware circuits, they can operate independently.

Therefore, as illustrated in FIG. 11, the read-and-write process 51b of (1) and the random number generation process 52a of (2) can be executed in parallel. That is, the random number generation process 52a in the second output random number obtaining operation can be executed in parallel with the read-and-write process 51b in the first output random number obtaining operation.

Similarly, the read-and-write process 52b of (2) and the random number generation process 53a of (3) can be executed in parallel. That is, the random number generation process 53a in the third output random number obtaining operation can be executed in parallel with the read-and-write process 52b in the second output random number obtaining operation.

### 3.3 Effects of Third Embodiment

According to the third embodiment, it is possible to provide a random number generation circuit that can randomly and efficiently output non-overlapping values from a certain range of values.

In the configuration of the third embodiment, in the processes (S2) to (S10) that are repeatedly executed X times, the random number generation process (S2) (or the remainder calculation process (S3)), the process of decrementing the variable “i” (S5), and the process of reading the value Q (S8) can be executed in parallel. This makes it possible to speed up the operation of obtaining the X output random numbers P. In other words, the time required to obtain X random numbers P can be reduced.

In the configuration of the third embodiment, as illustrated in FIG. 11, in the random number generation process 51a and the read-and-write process 51b that are repeatedly executed X times, the read-and-write process 51b that is executed before can be executed in parallel with the random number generation process 51a that is to be executed later. This makes it possible to speed up the operation of obtaining the X output random numbers P. In other words, the time required to obtain X output random numbers P can be reduced. Other effects are similar to those of the first embodiment described above.

### 4. FOURTH EMBODIMENT

A random number generation circuit according to a fourth embodiment will be described. In the fourth embodiment, an example is illustrated in which the addresses of the memory circuit 41 are divided into a first group and a second group, and the value stored in an address belonging to the first group is calculated as a small output random number, and the value stored in an address belonging to the second group is calculated as a large output random number. In the fourth embodiment, differences from the first embodiment will be mainly described.

### 4.1 Configuration of Fourth Embodiment

The addresses of the memory circuit 41 are, for example, represented by numbers. Hereinafter, the number representing an address will be referred to as an address number. In the fourth embodiment, the addresses of the memory circuit 41 are managed by being divided into two groups: a first group with small address numbers and a second group with large address numbers. The same value is stored in the storage area designated by the first group address and the storage area designated by the second group address. The storage state of the memory circuit 41 including addresses and values thereof will be described in detail below.

The other hardware configuration and functional block configuration of the random number generation circuit of the fourth embodiment are the same as those of the first embodiment described above.

### 4.2 Operation of Fourth Embodiment

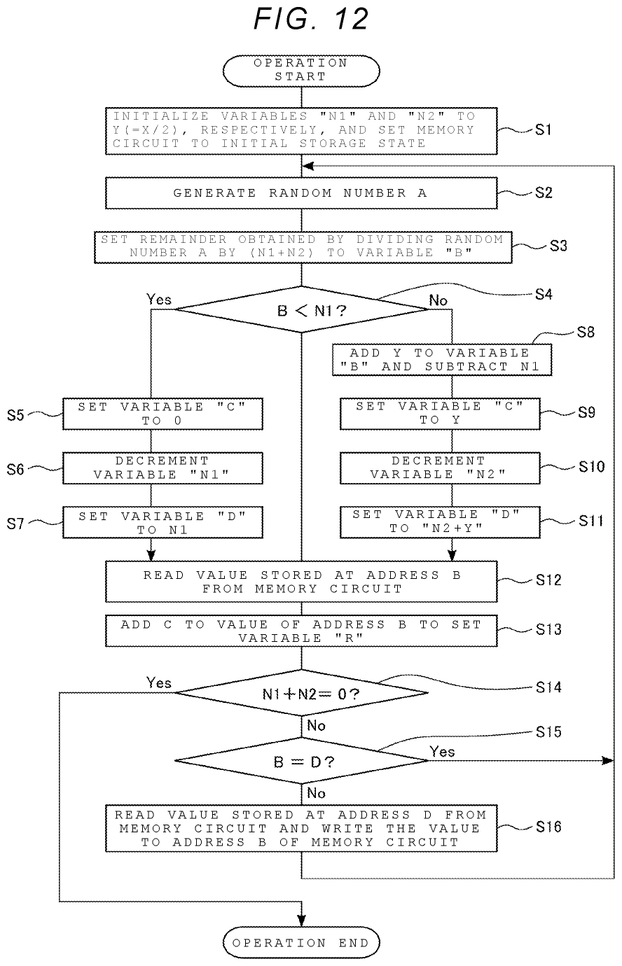

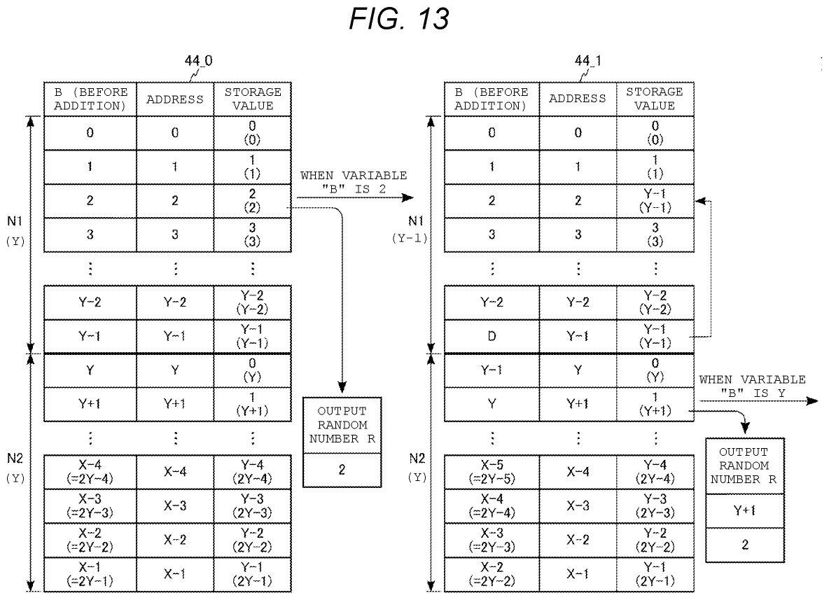

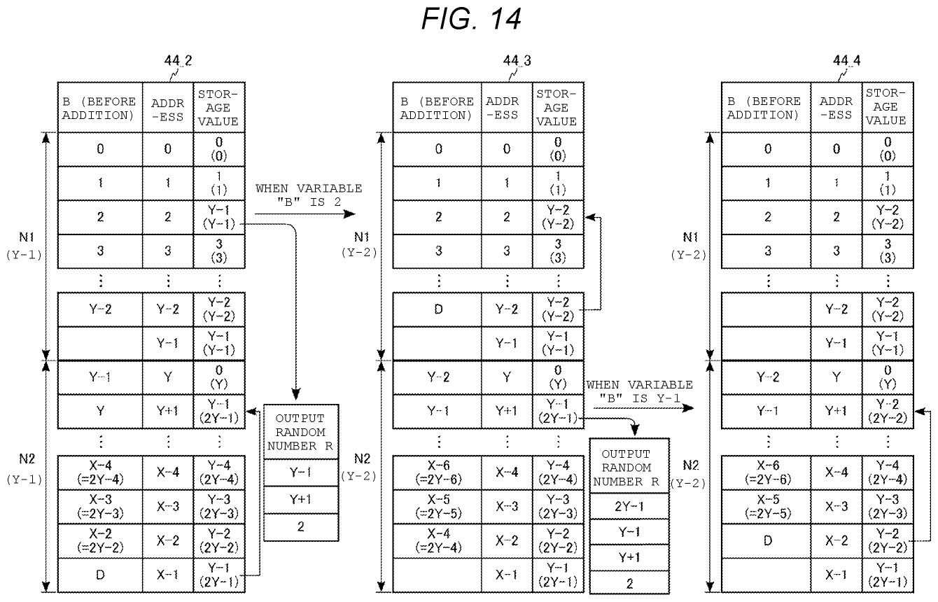

The random number generation circuit according to the fourth embodiment will be described. FIG. 12 is a flowchart illustrating the operation of the random number generation circuit of the fourth embodiment. The processing illustrated in this flowchart is controlled by the repetition control circuit (or sequencer) 31. FIGS. 13 and 14 illustrate the transition of the storage state of the memory circuit 41, and illustrate the remainder B, addresses of the memory circuit 41, and data (storage values) stored in these addresses.

The random number generation circuit 1 of the fourth embodiment randomly obtains X non-overlapping values from among the X values using Y (=X/2) values. Here, Y is an integer greater than or equal to 0 and smaller than or equal to (X/2). Here, X is an integer greater than or equal to 0. “N1”, “N2”, “B”, “C”, “D”, and “R” are prepared as variables used by the repetition control circuit 31 for calculation.

As illustrated in FIG. 12, first, the repetition control circuit 31 sets variables “N1” and “N2” to Y (=X/2), respectively (S1). The variables “N1” and “N2” are variables for managing the number of obtained output random numbers. The variables “N1” and “N2” are each integers smaller than or equal to (X/2).

Further, the repetition control circuit 31 sets the memory circuit 41 to an initial storage state 440 using the initial value write control circuit 21 (S1).

As illustrated in FIG. 13, the memory circuit 41 has addresses 0, 1, 2, 3, . . . , Y−2, Y−1, Y, Y+1, . . . , X−4, X−3, X−2, and X−1, for example. These addresses 0, 1, 2, . . . , and X−1 are divided into a first group with Y small address numbers and a second group with Y large address numbers. The first group includes addresses 0, 1, 2, 3, . . . , Y−2, and Y−1. The second group includes addresses Y, Y+1, . . . , X−4, X−3, X−2, and X−1.

When the memory circuit 41 is in the initial storage state 44_0, the storage values 0, 1, 2, 3, . . . , Y−2, and Y−1 are stored at the addresses 0, 1, 2, 3, . . . , Y−2, and Y−1 belonging to the first group, respectively, and the storage values 0, 1, . . . , Y−4, Y−3, Y−2, and Y−1 are stored at the addresses Y, Y+1, . . . , X−4, X−3, X−2, and X−1 belonging to the second group, respectively. That is, the same value 0 is stored at the address 0 and the address Y. The same value 1 is stored at the address 1 and the address (Y+1). The same value 2 is stored at the address 2 and the address (Y+2). Similarly, the same value is stored at an address in the first group and an address in the second group, respectively. It is noted that the values in parentheses described in the storage values in FIGS. 13 and 14 indicate values when output as output random numbers.

Next, the repetition control circuit 31 generates a random number (i.e., internal random number) A using the random number generator 11 (S2). The internal random number A is any integer.

Subsequently, the numerical range limiting circuit 12 of the repetition control circuit 31 performs processing to obtain a value in the range of 0 to (X−1) using the internal random number A. Specifically, the numerical range limiting circuit 12 divides the internal random number A by (N1+N2). The numerical range limiting circuit 12 sets the remainder calculated by this division to a variable “B” (S3). The value of the variable “B” is an integer greater than or equal to 0 and smaller than or equal to (X−1).

Next, the repetition control circuit 31 determines whether the variable “B” is smaller than the variable “N1” (S4). If the variable “B” is smaller than the variable “N1” (Yes in S4), the repetition control circuit 31 performs the processes in steps S5 to S7. First, the repetition control circuit 31 sets the variable “C” to 0 (S5). The variable “C” is a variable that is to be added to the storage value read from the memory circuit 41. Next, the repetition control circuit 31 decrements the variable “N1” (S6). Furthermore, the repetition control circuit 31 sets the value of the variable “N1” to the variable “D” (S7). The variable “D” is a variable indicating the maximum value among the values of addresses whose storage values have not yet been read. Thereafter, the process by the repetition control circuit 31 moves to step S12.

On the other hand, if the variable “B” is not smaller than the variable “N1” (No in S4), the repetition control circuit 31 performs the processes in steps S8 to S11. First, the repetition control circuit 31 adds Y to the variable “B” and subtracts the value of the variable “N1” (S8). The repetition control circuit 31 sets the variable “C” to Y (S9). The repetition control circuit 31 decrements the variable “N2” (S10). Furthermore, the repetition control circuit 31 sets the value of (N2+Y) to the variable “D” (S11). Thereafter, the process by the repetition control circuit 31 moves to step S12.

Next, in step S12, the repetition control circuit 31 regards the value of the variable “B” as an address of the memory circuit 41, and reads the value stored at the address B of the memory circuit 41 using the data read control circuit 22. Furthermore, the repetition control circuit 31 adds the value of the variable “C” to the value read from the address B and sets the obtained value to the variable “R” (S13). The variable “R” is an integer greater than or equal to 0 and smaller than or equal to (2Y−1). The value of this variable “R” is the output random number output from the memory control unit 20.

Next, the repetition control circuit 31 determines whether (N1+N2) is 0 (S14). If the (N1+N2) is 0 (Yes in S14), the repetition control circuit 31 ends the operation since the output random number R has been obtained X times.

On the other hand, if the (N1+N2) is not 0 (No in S14), the repetition control circuit 31 determines whether the variable “B” and the variable “D” are equal (S15). That is, the repetition control circuit 31 determines whether the value of the address B of the memory circuit 41 whose value was read in step S12 is the maximum value among the values of the addresses whose values have not yet been read in the first group or the second group.

If the variable “B” and the variable “D” are equal (Yes in S15), since the maximum value among the values of the addresses whose values have not been read out is the variable “B”, the repetition control circuit 31 skips step S16 and returns to step S2, and then repeats the processes from step S2 onwards.

On the other hand, if the variable “B” and the variable “D” are not equal (No in S15), the repetition control circuit 31 causes the read-and-write control circuit 23 to read out the value stored in a storage area of the memory circuit 41 (that is, the value stored at address D) indicated by the address of the value of the variable “D”, and writes the read value into the address B of the memory circuit 41 (S16). That is, the repetition control circuit 31 overwrites the address B from which the value was read in step S12 with the value read from the address D. Thereafter, the repetition control circuit 31 returns to step S2 and repeats the processes from step S2 onwards.

By repeating steps S2 to S16 described above, the random number generation circuit 1 uses a value from 0 to Y to obtain X output random numbers R that do not overlap among the X values.

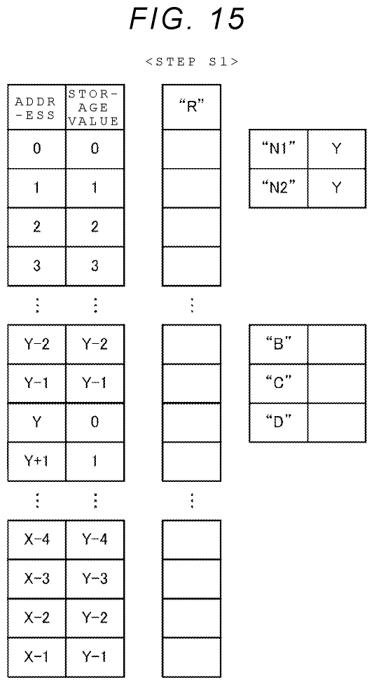

A specific operation of the random number generation circuit 1 of the fourth embodiment will be described below. FIGS. 15 to 31 illustrate the specific example of addresses and storage values in the memory circuit 41 during operation of the random number generation circuit 1, and the transition of the variables “N1”, “N2”, “B”, “C”, “D”, and “R”. It is noted that the operation of the random number generation circuit 1 is controlled by the repetition control circuit (or sequencer) 31.

As in step S1 of FIG. 12, the variables “N1” and “N2” are each set to Y. Furthermore, as illustrated in FIGS. 13 and 15, the memory circuit 41 is set to the initial storage state 44_0.

When the memory circuit 41 is in the initial storage state 44_0, the storage values 0, 1, 2, 3, . . . , Y−2, and Y−1 are stored at the addresses 0, 1, 2, 3, . . . , Y−2, and Y−1 belonging to the first group, respectively, and the storage values 0, 1, . . . , Y−4, Y−3, Y−2, and Y−1 are stored at the addresses Y, Y+1, . . . , X−4, X−3, X−2, and X−1 belonging to the second group, respectively.

Next, the first obtaining operation of the output random number R is executed.

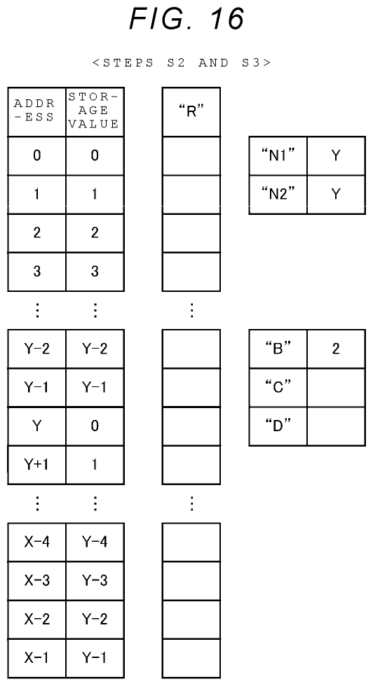

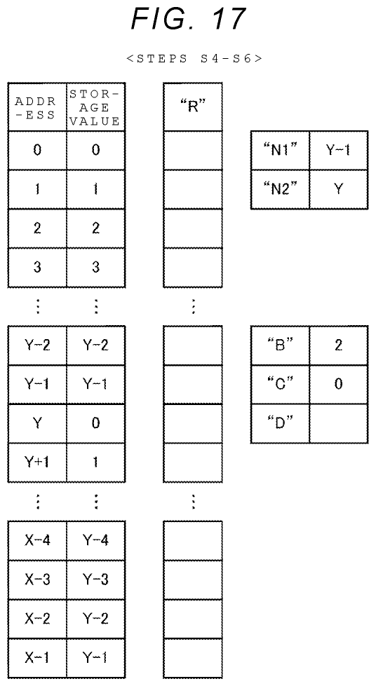

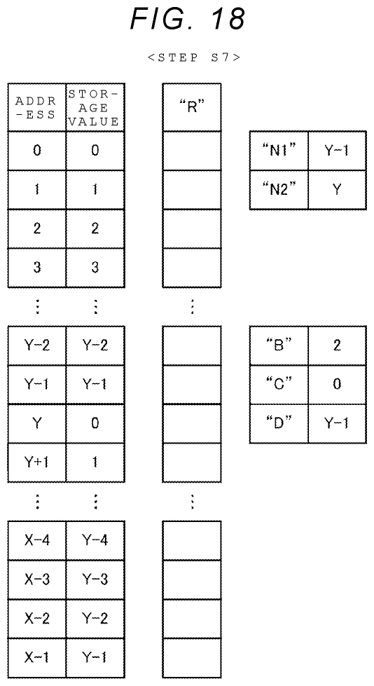

It is assumed that in steps S2 and S3 of FIG. 12, 2 is obtained as the remainder (i.e., variable “B”). Then, as illustrated in FIG. 16, the variable “B” is set to 2. Further, since the value 2 of the variable “B” is smaller than the value Y of the variable “N1” (Yes in S4), the processes of steps S5 to S7 are executed. As illustrated in FIG. 17, the variable “C” is set to 0, and the value of the variable “N1” is decremented from Y to become (Y−1) (S5 and S6). Furthermore, as illustrated in FIG. 18, the value (Y−1) of the variable “N1” is set to the variable “D” (S7).

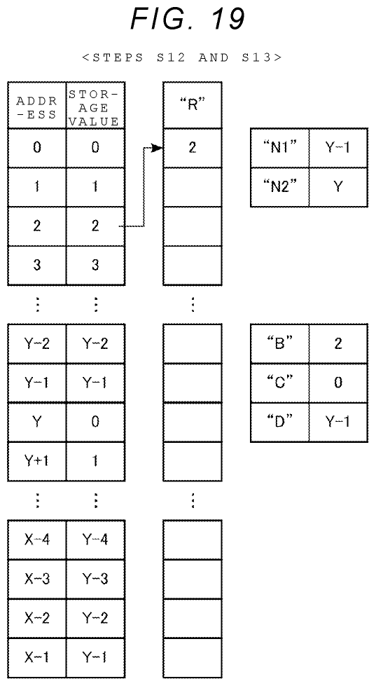

Next, as illustrated in FIG. 19, the value 2 stored at the address B (i.e., address 2) is read out (S12). Furthermore, the value 0 of the variable “C” is added to the read value 2, and the value 2 is set to the variable “R” (S13). Then, the value 2 of the variable “R” is obtained as an output random number.

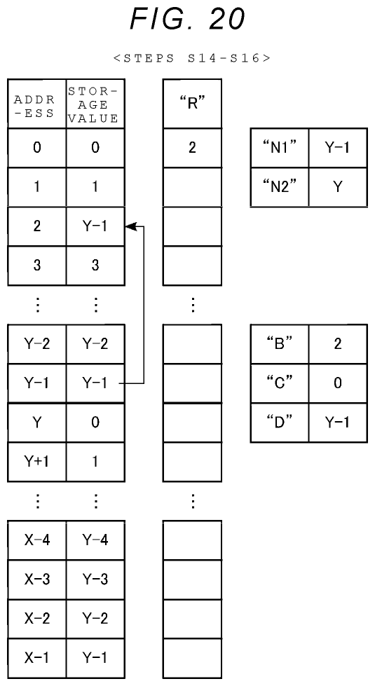

Next, as illustrated in FIG. 20, the value (Y−1) stored at the address D (i.e., address (Y−1)) is read out, and the read value (Y−1) is written to the address B (i.e., address 2) (S16). Note that this results in the storage state 44_1 in FIG. 13. With the above steps, the first obtaining operation of the output random number 2 is completed.

Next, the second obtaining operation of the output random number R is executed.

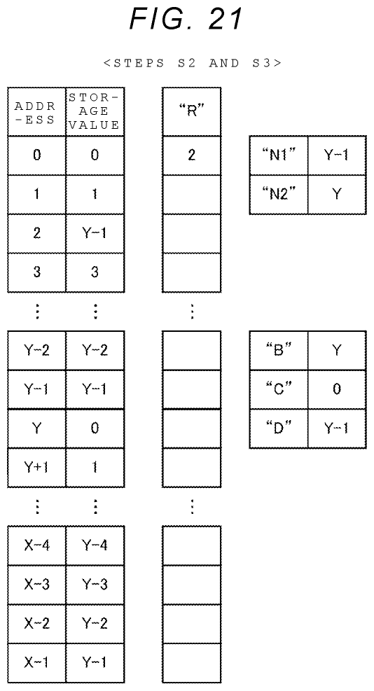

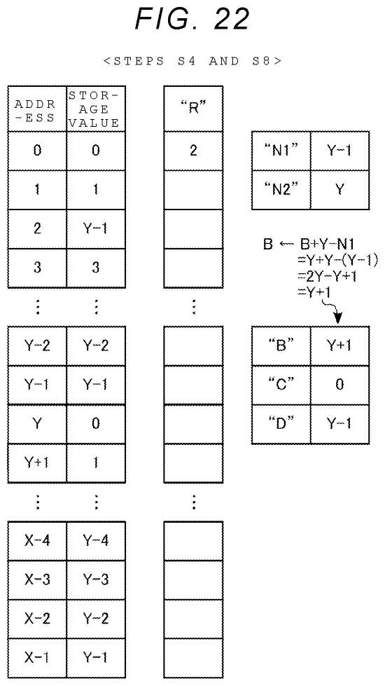

It is assumed that in steps S2 and S3 of FIG. 12, Y is obtained as the remainder (i.e., variable “B”). Then, as illustrated in FIG. 21, the variable “B” is set to Y. Further, since the value Y of the variable “B” is not smaller than the value (Y−1) of the variable “N1” (No in S4), the processes of steps S8 to S11 are executed. As illustrated in FIG. 22, Y is added to the variable “B” (having the value Y), and the value (Y−1) of the variable “N1” is subtracted from the variable “B”. As a result, (Y+1) is set to the variable “B” (S8).

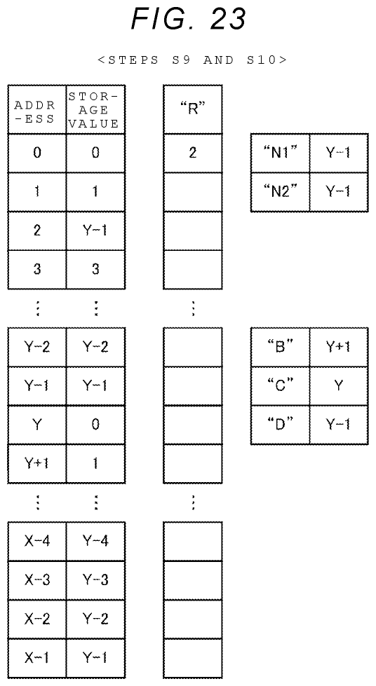

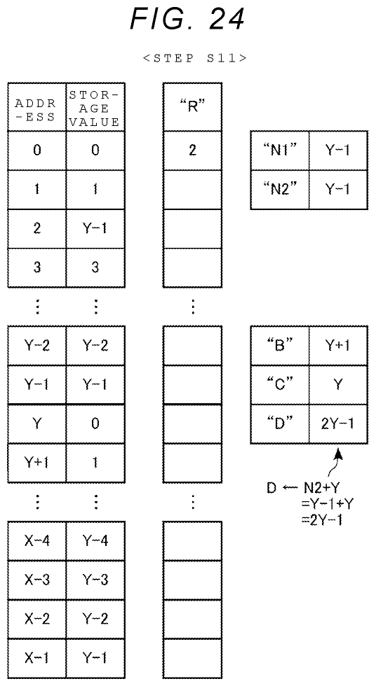

Next, as illustrated in FIG. 23, the variable “C” is set to Y, and the value of the variable “N2” is decremented from Y to become (Y−1) (S9 and S10). Furthermore, as shown in FIG. 24, the value of (N2+Y) is set to the variable “D”. That is, (2Y−1) is set to the variable “D” (S11).

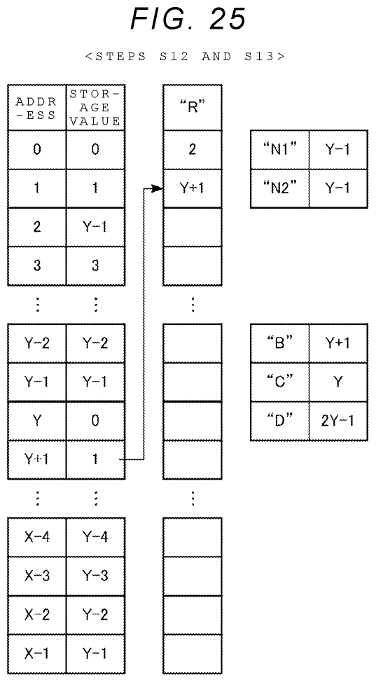

Next, as illustrated in FIG. 25, the value 1 stored at the address B (i.e., address (Y+1)) is read out (S12). Furthermore, the value Y of the variable “C” is added to the read value 1, and the value (Y+1) is set to the variable “R” (S13). Then, the value (Y+1) of the variable “R” is obtained as an output random number.

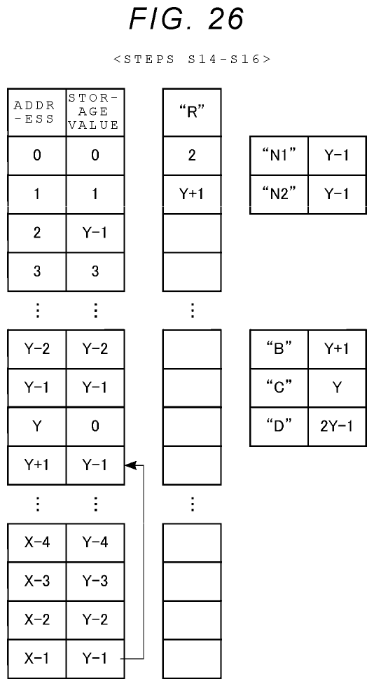

Next, as illustrated in FIG. 26, the value (Y−1) stored at the address D (i.e., address (X−1)) is read out, and the read value (Y−1) is written to the address B (i.e., address (Y+1)) (S16). Note that this results in the storage state 44_2 in FIG. 14. With the above steps, the second obtaining operation of the output random number (Y+1) is completed.

Next, the third obtaining operation of the output random number R is executed.

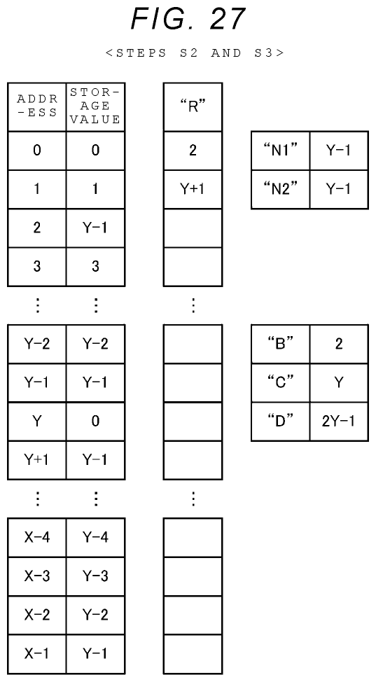

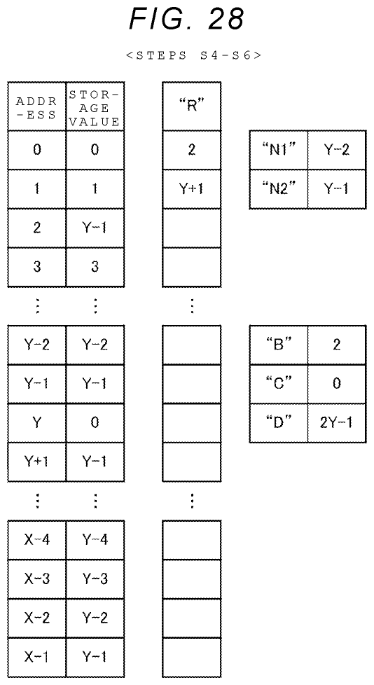

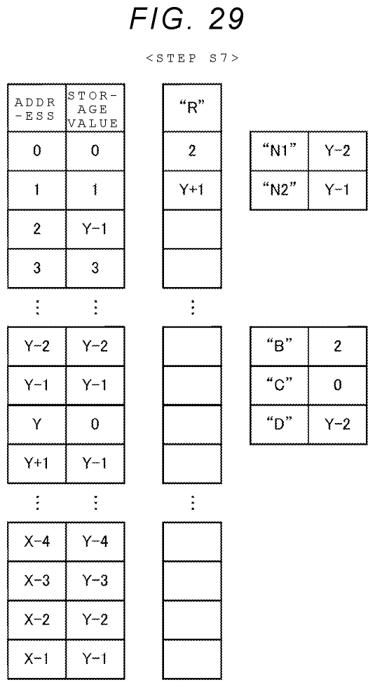

It is assumed that in steps S2 and S3 of FIG. 12, 2 is obtained as the remainder (i.e., variable “B”). Then, as illustrated in FIG. 27, the variable “B” is set to 2. Further, since the value 2 of the variable “B” is smaller than the value (Y−1) of the variable “N1” (Yes in S4), the processes of steps S5 to S7 are executed. As illustrated in FIG. 28, the variable “C” is set to 0, and the value of the variable “N1” is decremented from (Y−1) to become (Y−2) (S5 and S6). Furthermore, as illustrated in FIG. 29, the value (Y−2) of the variable “N1” is set to the variable “D” (S7).

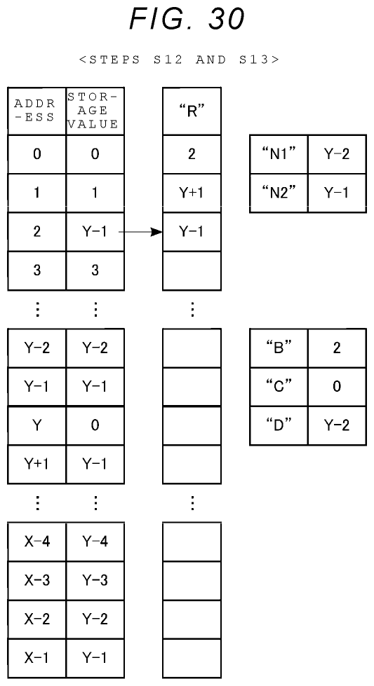

Next, as illustrated in FIG. 30, the value (Y−1) stored at the address B (i.e., address 2) is read out (S12). Furthermore, the value 0 of the variable “C” is added to the read value (Y−1), and the value (Y−1) is set to the variable “R” (S13). Then, the value (Y−1) of the variable “R” is obtained as an output random number.

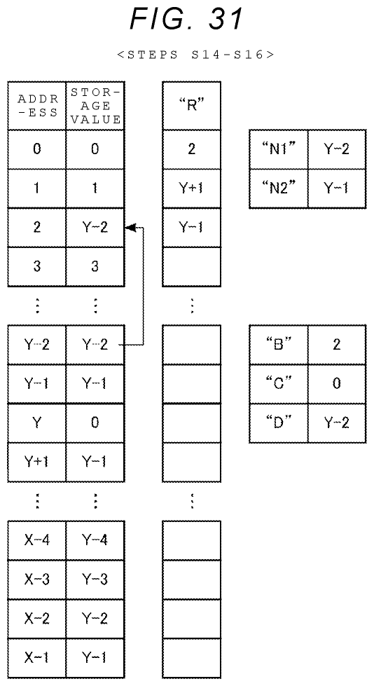

Next, as illustrated in FIG. 31, the value (Y−2) stored at the address D is read out, and the read value (Y−2) is written to the address B (i.e., address) 2 (S16). Note that this results in the storage state 44_3 in FIG. 13. With the above steps, the third obtaining operation of the output random number (Y−1) is completed.

Next, the fourth obtaining operation of the output random number R is executed. Here, a diagram illustrating transition of the addresses and storage values of the memory circuit 41 and the variables “N1”, “N2”, “B”, “C”, “D”, and “R” is omitted.

It is assumed that in steps S2 and S3 of FIG. 12, (Y−1) is obtained as the remainder (i.e., variable “B”). Then, the variable “B” is set to (Y−1). Further, since the value (Y−1) of the variable “B” is not smaller than the value (Y−2) of the variable “N1” (No in S4), the processes of steps S8 to S11 are executed. Y is added to the variable “B” (having the value (Y−1)), and the value (Y−2) of the variable “N1” is subtracted from the variable “B”. As a result, (Y+1) is set to the variable “B” (S8).

Next, the variable “C” is set to Y, and the value of the variable “N2” is decremented from (Y−1) to become (Y−2) (S9 and S10). Furthermore, the value of (N2+Y) is set to the variable “D”. That is, (2Y−1) is set to the variable “D” (S11).

Next, the value (Y−1) stored at the address B (i.e., address (Y+1)) is read out (S12). Furthermore, the value Y of the variable “C” is added to the read value (Y−1), and the value (2Y−1) is set to the variable “R” (S13). Then, the value (2Y−1) of the variable “R” is obtained as an output random number.

Next, the value (Y−2) stored at the address D (i.e., address (X−2)) is read out, and the read value (Y−2) is written to the address B (i.e., address (Y+1)) (S16). Note that this results in the storage state 44_4 in FIG. 14. With the above steps, the fourth obtaining operation of the output random number (2Y−1) is completed.

By repeating the random number obtaining operation described above X times, the random number generation circuit 1 can obtain X output random numbers that do not overlap from among X values, using the values from 0 to Y.

### 4.3 Modification of Fourth Embodiment

A random number generation circuit according to a modification of the fourth embodiment will be described. In the modification of the fourth embodiment, an example is illustrated in which the addresses of the memory circuit 41 are divided into a first group and a second group, and the value stored in an address belonging to the first group is calculated as an even output random number, and the value stored in an address belonging to the second group is calculated as an odd output random number.

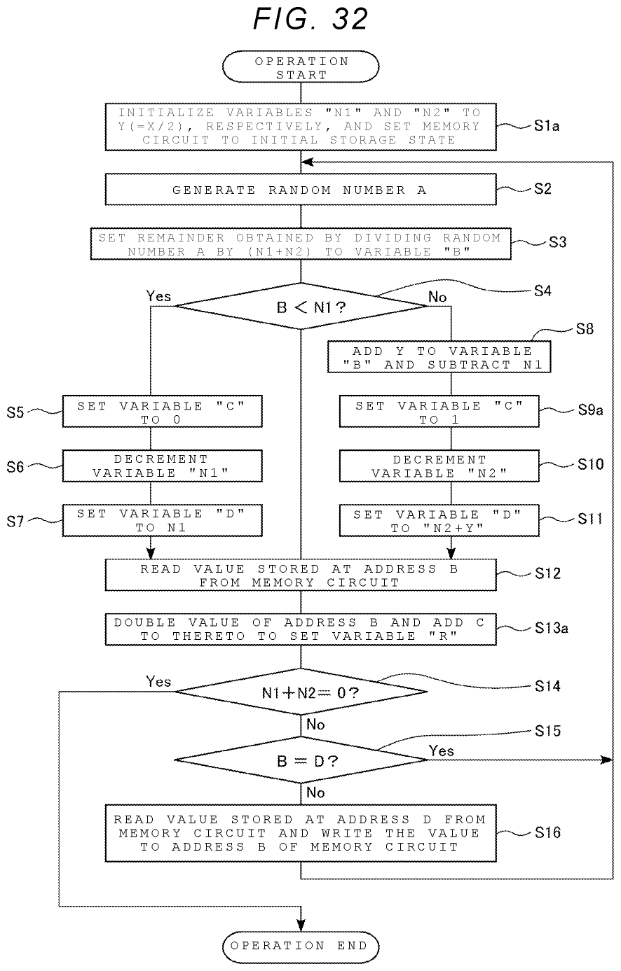

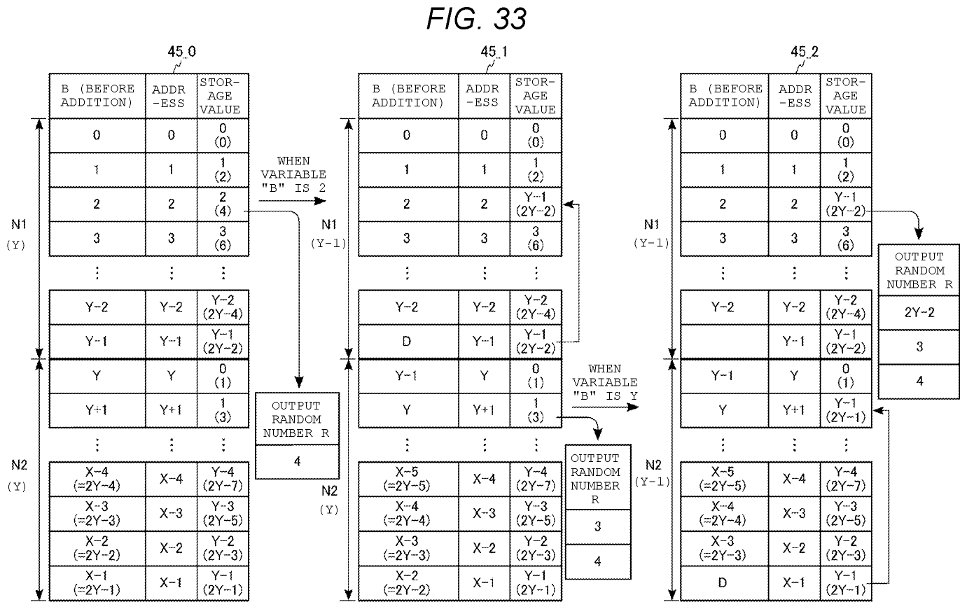

FIG. 32 is a flowchart illustrating the operation of the random number generation circuit of the modification of the fourth embodiment. The processing illustrated in this flowchart is controlled by the repetition control circuit (or sequencer) 31. FIG. 33 illustrates the transition of the storage state of the memory circuit 41. FIG. 33 illustrates the remainder B, addresses of the memory circuit 41, and data (storage values) stored in these addresses.

As illustrated in FIG. 32, first, the repetition control circuit 31 sets the variables “N1” and “N2” to Y (=X/2), respectively (Sla). The variables “N1” and “N2” are variables for managing the number of obtained output random numbers. The variables “N1” and “N2” are each integers smaller than or equal to (X/2).

Further, the repetition control circuit 31 sets the memory circuit 41 to the initial storage state 450 using the initial value write control circuit 21 (Sla).

The storage state 45_0 is the same as the storage state 44_0 in the fourth embodiment. When the memory circuit 41 is in the storage state 45_0, the storage values 0, 1, 2, 3, . . . , Y−2, and Y−1 are stored at the addresses 0, 1, 2, 3, . . . , Y−2, and Y−1 belonging to the first group, respectively, and the storage values 0, 1, . . . , Y−4, Y−3, Y−2, and Y−1 are stored at the addresses Y, Y+1, . . . , X−4, X−3, X−2, and X−1 belonging to the second group, respectively. That is, the same value is stored in the first group address and the second group address, respectively. It is noted that the values in parentheses described in the storage values in FIG. 33 indicate values when output as output random numbers.

The processes from step S2 to step S7 by the repetition control circuit 31 illustrated in FIG. 32 are similar to the processes from step S2 to step S7 illustrated in FIG. 12.

If the variable “B” is not smaller than the variable “N1” (No in S4), the repetition control circuit 31 performs the processes in steps S8 to S11. First, the repetition control circuit 31 adds Y to the variable “B” and subtracts the value of the variable “N1” (S8). Subsequently, the repetition control circuit 31 sets the variable “C” to 1 (S9a). The repetition control circuit 31 decrements the variable “N2” (S10). Furthermore, the repetition control circuit 31 sets the value of (N2+Y) to the variable “D” (S11). Thereafter, the process by the repetition control circuit 31 moves to step S12.

Next, in step S12, the repetition control circuit 31 regards the value of the variable “B” as an address of the memory circuit 41, and reads the value stored at the address B of the memory circuit 41 using the data read control circuit 22. Furthermore, the repetition control circuit 31 doubles the value read from the address B, and further adds the value of the variable “C” thereto and sets the obtained value to the variable “R” (S13a). The variable “R” is an integer greater than or equal to 0 and smaller than or equal to (2Y−1). The value of this variable “R” is the output random number output from the memory control unit 20.

The processes from step S14 to step S16 by the repetition control circuit 31 illustrated in FIG. 32 are similar to the processes from step S14 to step S16 illustrated in FIG. 12.

By repeating steps S2 to S16 described above, the random number generation circuit 1 uses a value from 0 to Y to obtain X output random numbers R that do not overlap among the X values.

A specific operation of the random number generation circuit 1 of the modification of the fourth embodiment will be described below with reference to FIGS. 32 and 33.

In step S1a of FIG. 32, the variables “N1” and “N2” are each set to Y. Furthermore, as illustrated in FIG. 33, the memory circuit 41 is set to the initial storage state 45_0.

When the memory circuit 41 is the initial storage state 45_0, the storage values 0, 1, 2, 3, . . . , Y−2, and Y−1 are stored at the addresses 0, 1, 2, 3, . . . , Y−2, and Y−1 belonging to the first group, respectively, and the storage values 0, 1, . . . , Y−4, Y−3, Y−2, and Y−1 are stored at the addresses Y, Y+1, . . . , X−4, X−3, X−2, and X−1 belonging to the second group, respectively.

Next, the first obtaining operation of the output random number R is executed.

It is assumed that in steps S2 and S3 of FIG. 32, 2 is obtained as the remainder (i.e., variable “B”). Since the value 2 of the variable “B” is smaller than the value Y of the variable “N1” (Yes in S4), the processes of steps S5 to S7 are executed. First, the variable “C” is set to 0 (S5). The variable “N1” is decremented from Y to (Y−1) (S6). The value (Y−1) of the variable “N1” is set to the variable “D” (S7).

Next, as illustrated in FIG. 33, the value 2 stored at the address B (i.e., address 2) is read out (S12). The read value 2 is doubled, the value 0 of the variable “C” is added, and the obtained value is set to the variable “R” (S13a). Then, the value 4 of the variable “R” is obtained as an output random number.

Thereafter, the value (Y−1) read from the address D (i.e., address (Y−1)) is written to the address B (i.e., address 2) (S16).

Also, by decrementing the variable “N1”, the range of addresses for which no output random numbers have been obtained becomes 0 to (Y−2) in the first group and Y to (X−1) in the second group. As a result, in the storage state 45_1 of the memory circuit 41, the storage values 0, 1, Y−1, 3, . . . , and Y−2 are stored at the addresses 0, 1, 2, 3, . . . , and Y−2 of the first group, respectively. Furthermore, the storage values 0, 1, . . . , Y−4, Y−3, Y−2, and Y−1 are stored at addresses Y, Y+1, . . . , X−4, X−3, X−2, and X−1 of the second group, respectively.

Next, the second obtaining operation of the output random number R is executed.

It is assumed that in steps S2 and S3 of FIG. 32, Y is obtained as the remainder (i.e., variable “B”). Then, since the value Y of the variable “B” is not smaller than the value (Y−1) of the variable “N1” (No in S4), the processes of steps S8 to S11 are executed. First, Y is added to the variable “B” and the value (Y−1) of the variable “N1” is subtracted from the variable “B”, and the obtained value (Y+1) is set to the variable “B” (S8). The variable “C” is set to 1 (S9a). The value of the variable “N2” is decremented from Y to (Y−1) (S10). Furthermore, (N2+Y) is set to the variable “D” (S11). That is, (2Y−1) is set to the variable “D”.

Next, as illustrated in FIG. 33, the value 1 stored at the address B (i.e., address (Y+1)) of the memory circuit 41 is read out (S12). The read value 1 is doubled, the value 1 of the variable “C” is added thereto, and the obtained value is set to the variable “R” (S13a). Then, the value 3 of the variable “R” is obtained as an output random number.

Thereafter, the value (Y−1) read from the address D (i.e., address (2Y−1), which is equal to address (x−1)) is written to the address B (i.e., address (Y+1)) (S16).

Also, by decrementing the variable “N2”, the range of addresses for which no output random numbers have been obtained becomes 0 to (Y−2) in the first group and Y to (X−2) in the second group. As a result, in the storage state 45_2 of the memory circuit 41, the storage values 0, 1, Y−1, 3, . . . , and Y−2 are stored at the addresses 0, 1, 2, 3, . . . , and Y−2 of the first group, respectively. Furthermore, the storage values 0, Y−1, . . . , Y−4, Y−3, and Y−2 are stored at the addresses Y, Y+1, . . . , X−4, X−3, and X−2 of the second group, respectively.

By repeating the random number obtaining operation described above X times, the random number generation circuit 1 can obtain X output random numbers that do not overlap from among X values, using the values from 0 to Y.

### 4.4 Effects of Fourth Embodiment

According to the fourth embodiment and the modification thereof, it is possible to randomly and efficiently output non-overlapping values from a certain range of values, and it is also possible to reduce the storage amount of values stored in the memory circuit.

In the fourth embodiment, the addresses of the memory circuit 41 are divided into the first group and the second group, and the same Y (=X/2) values (0 to (Y−1)) are stored at the addresses of the first group and the addresses of the second group, respectively. When obtaining X output random numbers, if the value stored in an address of the first group is read, that value is calculated as a smaller output random number (0 to (Y−1)) and if the value stored in an address of the second group is read out, the value is calculated as a larger output random number (Y to (2Y−1)).

Further, in the modification, the addresses of the memory circuit 41 are divided into the first group and the second group, and the same Y values (0 to (Y−1)) are stored at the addresses of the first group and the addresses of the second group, respectively. When obtaining X output random numbers, if the value stored in an address of the first group is read, the value is calculated as an even output random number (0, 2, 4, . . . , 2Y−4, 2Y− 2), and if the value stored in an address of the second group is read, the value is calculated as an odd output random number (1, 3, 5, . . . , 2Y−3, 2Y−1).

In the random number generation circuit 1 of the fourth embodiment and the modification, in order to obtain X output random numbers, it is not necessary to store values from 0 to (X−1) (i.e., 0 to (2Y−1)) in the memory circuit 41, and instead the values from 0 to (Y−1) may be stored in the memory circuit 41.

For example, when obtaining 1024 output random numbers (for example, integers from 0 to 1023), it is not necessary to store the integers from 0 to 1023 as values in the memory circuit 41; and instead the integers from 0 to 511 may be stored at the storage areas designated by the addresses of the first group and the second group, respectively. Note that 10 bits are required to represent an integer from 0 to 1023, but an integer from 0 to 511 can be represented using 9 bits. That is, in the fourth embodiment and the modification, the storage capacity required for the memory circuit 41 can be reduced. Other effects are similar to those of the first embodiment described above.

### 5. FIFTH EMBODIMENT

A random number generation circuit according to a fifth embodiment will be described. In the fifth embodiment, a memory area in the memory circuit 41 is divided into a first memory area and a second memory area, the value stored at an address of the first memory area is calculated as a small output random number (0 to Y−1), and the value written in an address of the second memory area is calculated as a large output random number (Y to (2Y−1)). In the fifth embodiment, differences from the first embodiment will be mainly described.

### 5.1 Configuration of Fifth Embodiment

The memory circuit 41 includes two memory areas M0 and M1. The memory area M0 and memory area M1 each have independent address ranges. The same value is stored at the same address in the memory area M0 and the memory area M1.

The other hardware configuration and functional block configuration of the random number generation circuit of the fifth embodiment are the same as those of the first embodiment described above.

### 5.2 Operation of Fifth Embodiment

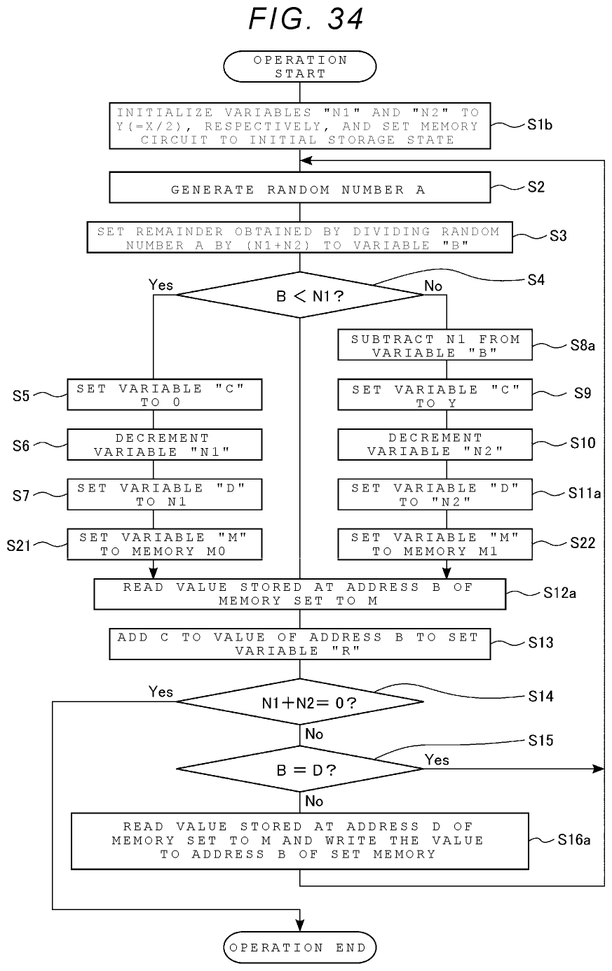

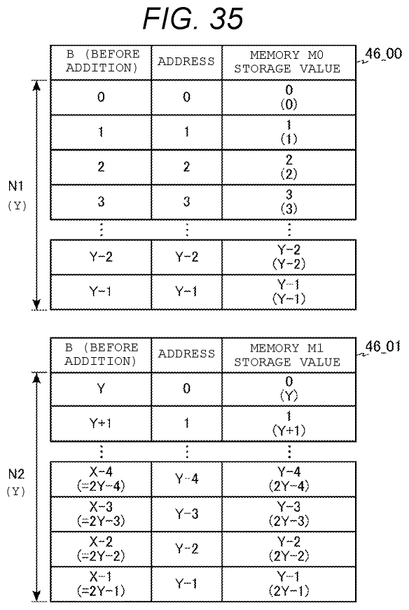

An operation of the random number generation circuit according to the fifth embodiment will be described. FIG. 34 is a flowchart illustrating the operation of the random number generation circuit of the fifth embodiment. The processing illustrated in this flowchart is controlled by the repetition control circuit (or sequencer) 31. FIG. 35 is a diagram illustrating the initial storage state of the memory areas M0 and M1.

Similarly to the fourth embodiment, the random number generation circuit 1 of the fifth embodiment randomly obtains X non-overlapping values from among the X values using Y (=X/2) values. Here, Y is an integer greater than or equal to 0 and smaller than or equal to (X/2). Here, X is an integer greater than or equal to 0. “N1”, “N2”, “B”, “C”, “D”, “R”, and “M” are prepared as variables used by the repetition control circuit 31 for calculation.

As illustrated in FIG. 34, first, the repetition control circuit 31 sets the variables “N1” and “N2” to Y (=X/2), respectively (S1b). The variables “N1” and “N2” are variables for managing the number of obtained output random numbers. The variables “N1” and “N2” are each integers smaller than or equal to (X/2).

Furthermore, the repetition control circuit 31 sets the memory areas M0 and M1 to the initial storage states 46_00 and 46_01, respectively, using the initial value write control circuit 21 (S1b).

As illustrated in FIG. 35, for example, the memory area M0 has the addresses 0, 1, 2, 3, . . . , Y−4, Y−3, Y−2, and Y−1. Similarly, the memory area M1 has the addresses 0, 1, 2, 3, . . . , Y−4, Y−3, Y−2, and Y−1. That is, the memory areas M0 and M1 have the same addresses.

When the memory area M0 is in the initial storage state 46_00, the storage values 0, 1, 2, 3, . . . , Y−2, and Y−1 are stored at the addresses 0, 1, 2, 3, . . . , Y−2, and Y−1, respectively. When the memory area M1 is in the initial storage state 46_01, the storage values 0, 1, . . . , Y−4, Y−3, Y−2, and Y−1 are stored at the addresses 0, 1, . . . , Y−4, Y−3, Y−2, and Y−1, respectively. That is, the storage value 0 is stored at the address 0 of the memory area M0 and the memory area M1. The storage value 1 is stored at the address 1 of the memory area M0 and the memory area M1. Similarly, the storage values 2 to (Y−1) are stored at the addresses 2 to (Y−1) of the memory area M0 and the memory area M1, respectively. It is noted that the values in parentheses described in the storage values in FIG. 35 indicate values when output as output random numbers.

The processes from step S2 to step S4 by the repetition control circuit 31 illustrated in FIG. 34 are similar to the processes from step S2 to step S4 illustrated in FIG. 12.

Next, if the variable “B” is smaller than the variable “N1” (Yes in S4), the repetition control circuit 31 performs the processes in steps S5 to S7 and S21. The processes from step S5 to step S7 by the repetition control circuit 31 illustrated in FIG. 34 are similar to the processes from step S5 to step S7 illustrated in FIG. 12. Further, the repetition control circuit 31 sets a value indicating that the memory area M0 is selected to the variable “M” (S21). Thereafter, the process by the repetition control circuit 31 moves to step S12a.

On the other hand, if the variable “B” is not smaller than the variable “N1” (No in S4), the repetition control circuit 31 performs the processes in steps S8, S9, S10, S11a, and S22. First, the repetition control circuit 31 subtracts the value of the variable “N1” from the variable “B” (S8a). Subsequently, the repetition control circuit 31 sets the variable “C” to Y (S9). The repetition control circuit 31 decrements the variable “N2” (S10). The repetition control circuit 31 sets the value of the variable “N2” to the variable “D” (S11a). Further, the repetition control circuit 31 sets a value indicating that the memory area M1 is selected to the variable “M” (S22). Thereafter, the process by the repetition control circuit 31 moves to step S12a.

Next, in step S12a, the repetition control circuit 31 regards the value of the variable “B” as an address of the memory area M0 or M1, and reads out the value stored at the address “B” of one of the memory area M0 and the memory area M1 which is set to the variable “M”, using the data read control circuit 22.

The processes from step S13 to step S15 by the repetition control circuit 31 illustrated in FIG. 34 are similar to the processes from step S13 to step S15 illustrated in FIG. 12.

If the variable “B” and the variable “D” are not equal (No in S15), the repetition control circuit 31 causes the read-and-write control circuit 23 to read the value stored at the address D of the memory area set to the variable “M”, and to write the read value into the address B of the memory area set to the variable “M” (S16a). That is, the repetition control circuit 31 overwrites the address B from which the value was read in step S12a with the value read from the address D. Thereafter, the repetition control circuit 31 returns to step S2 and repeats the processes from step S2 onwards.

By repeating steps S2 to S16a described above, the random number generation circuit 1 uses a value from 0 to Y to obtain X output random numbers R that do not overlap among the X values.

### 5.3 Modification of Fifth Embodiment

Similarly to the modification of the fourth embodiment, in the fifth embodiment as well, the memory circuit 41 is divided into a region for even output random numbers and a region for odd output random numbers. That is, in the modification of the fifth embodiment, the memory area in the memory circuit 41 is divided into a first memory area and a second memory area. Then, the value stored at an address of the first memory area is calculated as an even output random number, and the value stored at an address of the second memory area is calculated as an odd output random number.

### 5.4 Effects of Fifth Embodiment

According to the fifth embodiment and the modification thereof, it is possible to randomly and efficiently output non-overlapping values from a certain range of values, and it is also possible to reduce the storage amount of values stored in the memory circuit. In the fourth embodiment and modification, for example, the address range of one SRAM is divided into a first group and a second group. In the fifth embodiment and modification, for example, two SRAMs are allocated to the memory areas M0 and M1, respectively. Such a configuration also provides the same effects as the fourth embodiment and the modification.

### 6. SIXTH EMBODIMENT

A random number generation circuit according to a sixth embodiment will be described. The sixth embodiment illustrates an example in which the memory area in the memory circuit 41 is divided into four memory areas, and an output random number is calculated according to each memory area. In the sixth embodiment, differences from the first embodiment will be mainly described.

### 6.1 Configuration of Sixth Embodiment

The memory circuit 41 in the sixth embodiment includes four memory areas M0, M1, M2, and M3. The memory areas M0, M1, M2, and M3 each have independent address ranges. The same value is stored at the same address of the memory areas M0, M1, M2, and M3.

The other hardware configuration and functional block configuration of the random number generation circuit of the sixth embodiment are the same as those of the first embodiment described above.

### 6.2 Operation of Sixth Embodiment

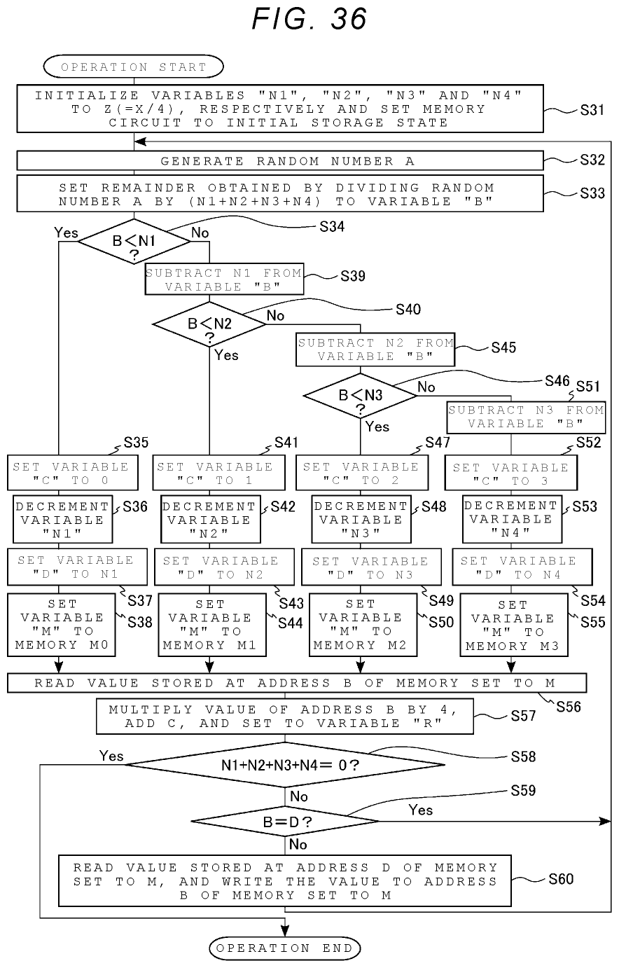

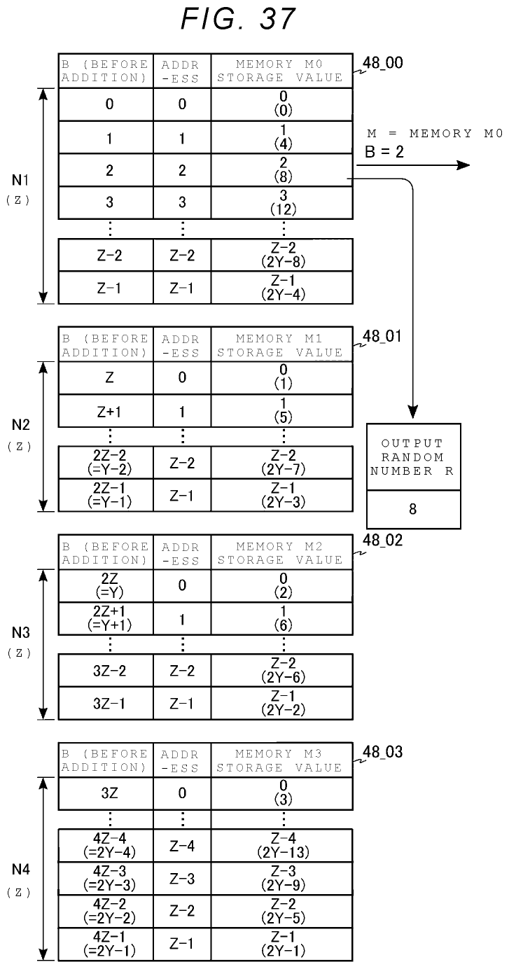

An operation of the random number generation circuit according to the sixth embodiment will be described. FIG. 36 is a flowchart illustrating the operation of the random number generation circuit of the sixth embodiment. The processing illustrated in this flowchart is controlled by the repetition control circuit (or sequencer) 31. FIGS. 37 to 39 are diagrams illustrating the transition of storage states in the memory areas M0, M1, M2, and M3. FIGS. 37 to 39 illustrate the remainder B, addresses of the memory areas M0, M1, M2, and M3, and data (storage values) stored at these addresses.

The random number generation circuit 1 of the sixth embodiment randomly obtains X non-overlapping values from among the X values using Z (=X/4) values. Here, Z is an integer greater than or equal to 0 and smaller than or equal to (X/4). Here, X is an integer greater than or equal to 0. “N1”, “N2”, “N3”, “N4”, “B”, “C”, “D”, “R”, and “M” are prepared as variables used by the repetition control circuit 31 for calculation.

As illustrated in FIG. 36, first, the repetition control circuit 31 sets the variables “N1”, “N2”, “N3”, and “N4” to Z (=Y/2=X/4) (S31). The variables “N1”, “N2”, “N3”, and “N4” are variables for managing the number of obtained output random numbers. The variables “N1”, “N2”, “N3”, and “N4” are each integers smaller than or equal to (X/4).

Further, the repetition control circuit 31 causes the initial value write control circuit 21 to set the memory areas M0, M1, M2, and M3 to the initial storage states 48_00, 48_01, 48_02, and 48_03, respectively (S31).

As illustrated in FIG. 37, for example, the memory areas M0, M1, M2, and M3 have the addresses 0, 1, 2, 3, . . . , Z−4, Z−3, Z−2, and Z−1, respectively. That is, the memory areas M0, M1, M2, and M3 have the same addresses.

When the memory areas M0, M1, M2, and M3 are in the initial storage states 48_00, 48_01, 48_02, and 48_03, respectively, the storage values 0, 1, 2, 3, . . . , Z−4, Z−3, Z−2, and Z−1 are stored at the addresses 0, 1, 2, 3, . . . , Z−4, Z−3, Z−2, and Z−1, respectively. That is, the storage value 0 is stored at the address 0 of the memory areas M0, M1, M2, and M3. The storage value 1 is stored at the address 1 of the memory areas M0, M1, M2, and M3. Similarly, the storage values 2 to (Z−1) are stored at the addresses 2 to (Z−1) of the memory areas M0, M1, M2, and M3, respectively. The values in parentheses described in the storage values in FIGS. 37 to 39 indicate values when output as output random numbers.

Next, the repetition control circuit 31 generates a random number (i.e., internal random number) A using the random number generator 11 (S32). The internal random number A is any integer.

Subsequently, the numerical range limiting circuit 12 of the repetition control circuit 31 performs processing to obtain a value in the range of 0 to (X−1) using the internal random number A. Specifically, the numerical range limiting circuit 12 divides the internal random number A by (N1+N2+N3+N4). The numerical range limiting circuit 12 sets the remainder calculated by this division to the variable “B” (S33). The value of the variable “B” is an integer greater than or equal to 0 and smaller than or equal to (X−1).

Next, the repetition control circuit 31 determines whether the variable “B” is smaller than the variable “N1” (S34). If the variable “B” is smaller than the variable “N1” (Yes in S34), the repetition control circuit 31 performs the processes in steps S35 to S38. First, the repetition control circuit 31 sets the variable “C” to 0 (S35). Next, the repetition control circuit 31 decrements the variable “N1” (S36). The repetition control circuit 31 sets the value of the variable “N1” to the variable “D” (S37). Further, the repetition control circuit 31 sets a value indicating that the memory area M0 is selected to the variable “M” (S38). Thereafter, the process by the repetition control circuit 31 moves to step S56.

If the variable “B” is not smaller than the variable “N1” (No in S34), the repetition control circuit 31 performs the processes in steps S39 onwards. First, the repetition control circuit 31 subtracts the value of the variable “N1” from the variable “B” (S39). Subsequently, the repetition control circuit 31 determines whether the variable “B” is smaller than the variable “N2” (S40). If the variable “B” is smaller than the variable “N2” (Yes in S40), the repetition control circuit 31 performs the processes in steps S41 to S44. First, the repetition control circuit 31 sets the variable “C” to 1 (S41). Next, the repetition control circuit 31 decrements the variable “N2” (S42). The repetition control circuit 31 sets the value of the variable “N2” to the variable “D” (S43). Further, the repetition control circuit 31 sets a value indicating that the memory area M1 is selected to the variable “M” (S44). Thereafter, the process by the repetition control circuit 31 moves to step S56.

If the variable “B” is not smaller than the variable “N2” (No in S40), the repetition control circuit 31 performs the processes in steps S45 onwards. First, the repetition control circuit 31 subtracts the value of the variable “N2” from the variable “B” (S45). Subsequently, the repetition control circuit 31 determines whether the variable “B” is smaller than the variable “N3” (S46). If the variable “B” is smaller than the variable “N3” (Yes in S46), the repetition control circuit 31 performs the processes in steps S47 to S50. First, the repetition control circuit 31 sets the variable “C” to 2 (S47). Subsequently, the repetition control circuit 31 decrements the variable “N3” (S48). The repetition control circuit 31 sets the value of the variable “N3” to the variable “D” (S49). Further, the repetition control circuit 31 sets a value indicating that the memory area M2 is selected to the variable “M” (S50). Thereafter, the process by the repetition control circuit 31 moves to step S56.

If the variable “B” is not smaller than the variable “N3” (No in S46), the repetition control circuit 31 performs the processes in steps S51 to S55. First, the repetition control circuit 31 subtracts the value of the variable “N3” from the variable “B” (S51). Subsequently, the repetition control circuit 31 sets the variable “C” to 3 (S52). The repetition control circuit 31 decrements the variable “N4” (S53). The repetition control circuit 31 sets the value of the variable “N4” to the variable “D” (S54). Further, the repetition control circuit 31 sets a value indicating that the memory area M3 is selected to the variable “M” (S55). Thereafter, the process by the repetition control circuit 31 moves to step S56.

Next, in step S56, the repetition control circuit 31 regards the value of the variable “B” as an address of the memory area M0, M1, M2, or M3, and reads the value stored at the address B of the memory area set to the variable “M” using the data read control circuit 22.

Furthermore, the repetition control circuit 31 multiplies the value read from the address B by 4, and further adds the value of the variable “C” and sets the obtained value to the variable “R” (S57). The variable “R” is an integer greater than or equal to 0 and smaller than or equal to (2Y−1). The value of this variable “R” is the output random number output from the memory control unit 20.

Next, the repetition control circuit 31 determines whether (N1+N2+N3+N4) is 0 (S58). If (N1+N2+N3+N4) is 0 (Yes in S58), the repetition control circuit 31 ends the operation since X output random numbers R have been obtained.

On the other hand, if the (N1+N2+N3+N4) is not 0 (No in S58), the repetition control circuit 31 determines whether the variable “B” and the variable “D” are equal (S59). That is, the repetition control circuit 31 determines whether the value of the address B of the memory area whose value was read in step S56 is the maximum value among the values of the address whose value has not been read yet.

If the variable “B” and the variable “D” are equal (Yes in S59), since the maximum value among the values of the addresses whose values have not been read out is the variable “B”, the repetition control circuit 31 skips step S60 and returns to step S32, and then repeats the processes from step S32 onwards.

On the other hand, if the variable “B” and the variable “D” are not equal (No in S59), the repetition control circuit 31 causes the read-and-write control circuit 23 to read the value stored at the address D of the memory area set to the variable “M” and to write the read value into the address B of the memory area set to the variable “M” (S60). That is, the repetition control circuit 31 overwrites the address B from which the value was read in step S56 with the value read from the address D. Thereafter, the repetition control circuit 31 returns to step S32 and repeats the processes from step S32 onwards.

By repeating steps S32 to S60 described above, the random number generation circuit 1 uses a value from 0 to Z to obtain X output random numbers R that do not overlap among the X values.

A specific operation of the random number generation circuit 1 of the sixth embodiment will be described below with reference to FIGS. 36 to 39.

As in step S31 of FIG. 36, the variables “N1”, “N2”, “N3” and “N4” are each set to Z. Further, as shown in FIG. 37, the memory areas M0, M1, M2, and M3 are set to the initial storage states 48_00, 48_01, 48_02, and 48_03, respectively.

When the memory areas M0, M1, M2, and M3 are in the initial storage states 48_00, 48_01, 48_02, and 48_03 respectively, the storage values 0, 1, 2, 3, . . . , Z−4, Z−3, Z−2, and Z−1 are stored at the addresses 0, 1, 2, 3, . . . , Z−4, Z−3, Z−2, and Z−1, respectively.

Next, the first obtaining operation of the output random number R is executed.

It is assumed that in steps S32 and S33 of FIG. 36, 2 is obtained as the remainder (i.e., variable “B”). Since the value 2 of the variable “B” is smaller than the value Z of the variable “N1” (Yes in S34), the processes of steps S35 to S38 are executed. First, the variable “C” is set to 0 (S35). The value of the variable “N1” is decremented from Z to (Z−1) (S36). The value (Z−1) of the variable “N1” is set to the variable “D” (S37). Further, a value indicating that the memory area M0 is selected is set to the variable “M” (S38).

Next, as illustrated in FIG. 37, the value 2 stored at the address B (i.e., address 2) of the memory area M0 is read out (S56). The read value 2 is multiplied by 4, the value 0 of the variable “C” is added, and the result is set as the variable “R” (S57). Then, the value 8 of the variable “R” is obtained as an output random number.

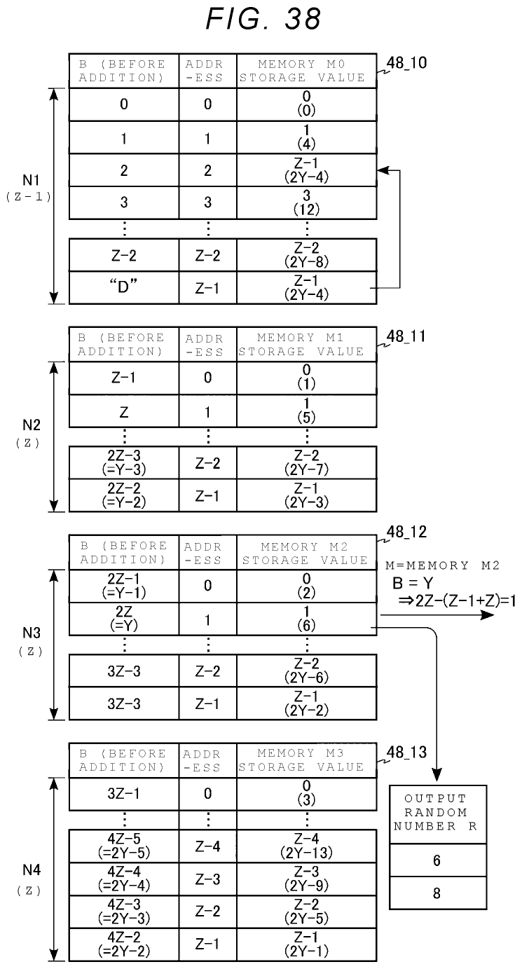

Thereafter, as illustrated in FIG. 38, the value (Z−1) read from the address D (i.e., address (Z−1)) is written to the address B (i.e., address 2) (S60).

Also, by decrementing the variable “N1”, the ranges of addresses for which no output random numbers have been obtained become 0 to (Z−2) in the memory area M0, 0 to (Z−1) in the memory area M1, 0 to (Z−1) in the memory area M2, and 0 to (Z−1) in the memory area M3. As a result, in the storage state 48_10 of the memory area M0, the storage values 0, 1, Z−1, 3, . . . , and Z−2 are stored at the addresses 0, 1, 2, 3, . . . , and Z−2, respectively. In the storage states 48_11, 48_12, and 48_13 of the memory areas M1, M2, and M3, the storage values 0, 1, . . . , Z−2, and Z−1 are stored at the addresses 0, 1, . . . , Z−2, and Z−1, respectively.

Next, the second obtaining operation of the output random number R is executed.

It is assumed that in steps S32 and S33 of FIG. 36, Y (=2Z) is obtained as the remainder (i.e., variable “B”). Since the value 2Z of the variable “B” is not smaller than the value (Z−1) of the variable “N1” (No in S34), the processes of steps S39 onwards are executed. The value (Z−1) of the variable “N1” is subtracted from the variable “B” having the value 2Z, and the obtained value (Z+1) is set to the variable “B” (S39).

Next, since the value (Z+1) of the variable “B” is not smaller than the value Z of the variable “N2” (No in S40), the processes of steps S45 onwards are executed. The value Z of the variable “N2” is subtracted from the variable “B” having the value (Z+1), and the obtained value 1 is set to the variable “B” (S45).

Next, since the value 1 of the variable “B” is smaller than the value Z of the variable “N3” (Yes in S46), the processes of steps S47 to S50 are executed. First, the variable “C” is set to 2 (S47). The value of the variable “N3” is decremented from Z to (Z−1) (S48). The value (Z−1) of the variable “N3” is set to the variable “D” (S49). Further, a value indicating that the memory area M2 is selected is set to the variable “M” (S50).

Next, as illustrated in FIG. 38, the value 1 stored at the address B (i.e., address 1) of the memory area M2 is read out (S56). The read value 1 is multiplied by 4, the value 2 of the variable “C” is added, and the result is set as the variable “R” (S57). Then, the value 6 of the variable “R” is obtained as an output random number.

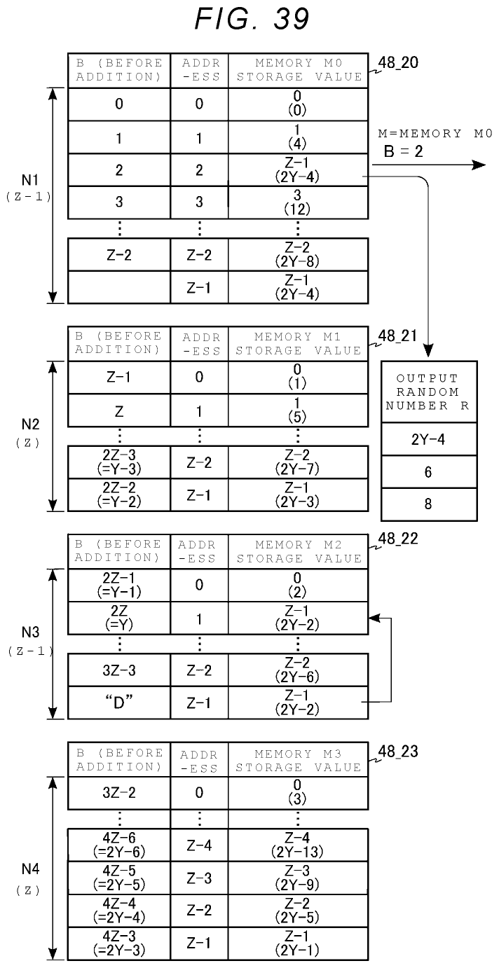

Thereafter, as illustrated in FIG. 39, the value (Z−1) read from the address D (i.e., address (Z−1)) is written to the address B (i.e., address 1) (S60).

Also, by decrementing the variable “N3”, the ranges of addresses for which no output random numbers have been obtained become 0 to (Z−2) in the memory area M0, 0 to (Z−1) in the memory area M1, 0 to (Z−2) in the memory area M2, and 0 to (Z−1) in the memory area M3. As a result, in the storage state 48_20 of the memory area M0, the storage values 0, 1, Z−1, 3, . . . , and Z−2 are stored at the addresses 0, 1, 2, 3, . . . , and Z−2, respectively. In the storage states 48_21 and 48_23 of the memory areas M1 and M3, the storage values 0, 1, . . . , Z−2, and Z−1 are stored at the addresses 0, 1, . . . , Z−2, and Z−1, respectively. In the storage state 48_22 of the memory area M2, the storage values 0, Z−1, . . . , and Z−2 are stored at the addresses 0, 1, . . . , and Z−2, respectively.

By repeating the random number obtaining operation described above X times, the random number generation circuit 1 can obtain X output random numbers that do not overlap from among X values, using the values from 0 to Z.

### 6.3 Effects of Sixth Embodiment

According to the sixth embodiment, it is possible to randomly and efficiently output non-overlapping values from a certain range of values, and it is also possible to reduce the storage amount of values stored in the memory circuit. In the fifth embodiment and modification, for example, two SRAMs were allocated to the memory areas M0 and M1, respectively. In the sixth embodiment, for example, four SRAMs are allocated to the memory areas M0, M1, M2, and M3, respectively. Such a configuration also provides the same effects as the fifth embodiment and the modification.

For example, when obtaining 1024 output random numbers (for example, integers from 0 to 1023), it is not necessary to store the values 0 to 1023 in the address range 0 to 1023 of the memory circuit 41, but instead 0 to 255 may be stored as values in the address range 0 to 255 of the memory areas M0, M1, M2, and M3, respectively. Note that 10 bits are required to represent an integer from 0 to 1023, but an integer from 0 to 255 can be represented using 8 bits. That is, in the sixth embodiment, the storage capacity required for the memory circuit 41 can be reduced. Other effects are similar to those of the first embodiment described above.

### 7. OTHERS

The random number generation circuit of the embodiments described above can also be expressed as follows.

The random number generation circuit of the embodiment includes a memory circuit and a control circuit. The memory circuit includes a plurality of storage areas each designated by one of a plurality of addresses (e.g., 0 to Y) (Y is an integer greater than or equal to 1).

The control circuit is configured to store a plurality of values, all of which are different from each other (for example, 0 to Y), in the plurality of storage areas, to generate a first random number (for example, internal random number A), to obtain a first address (for example, address B) that is one of the plurality of addresses using the first random number, to read out a first value (for example, value P) stored in the first storage area designated by the first address, and to read out a second value (for example, value Q) stored in a second storage area designated by a second address (for example, address j) among the plurality of storage areas. The second address is an address having the largest value among a range of addresses from which the first address can be obtained. The control circuit is configured to write the second value into the first storage area after reading the first value therefrom. The control circuit is configured to output the first value as one value of an output random number.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A random number generation circuit comprising:
a memory circuit including a plurality of storage areas each designated by one of a plurality of addresses; and
a control circuit configured to:
(a) store a plurality of values, all of which are different from each other, in the plurality of storage areas, respectively;
(b) generate a first random number;
(c) obtain a first address that is one of the plurality of addresses using the first random number;
(d) read a first value stored in a first storage area designated by the first address;
(e) read a second value stored in a second storage area designated by a second address that is an address having the largest value among a range of addresses from which the first address can be obtained;
(f) write the second value in the first storage area after reading the first value therefrom; and
(g) output the first value as one value of an output random number.

2. The random number generation circuit according to claim 1, wherein
the number of the plurality of values is (Y+1), where Y is an integer greater than or equal to 1,
the plurality of addresses are integers greater than or equal to 0 and smaller than or equal to Y, and
the control circuit is configured to store an integer greater than or equal to 0 and smaller than or equal to Y in each of the plurality of storage areas as one of the plurality of values.

3. The random number generation circuit according to claim 2, wherein
the control circuit is configured to divide the first random number by (Y+1) and obtain a resulting remainder as the first address.

4. The random number generation circuit according to claim 1, wherein
the control circuit is configured to divide the first random number by the number of addresses in the range, and obtain a resulting remainder as the first address.

5. The random number generation circuit according to claim 1, wherein
the control circuit is further configured to (h) narrow the range of addresses that can be obtained as the first address by removing from the range the address having the largest value among the addresses in the range, and repeat the process from (b) to (h) a first number of times.

6. The random number generation circuit according to claim 5, wherein
the first number of times is different from the number of the plurality of values.

7. The random number generation circuit according to claim 5, wherein
the first number of times is equal to the number of the plurality of values.

8. The random number generation circuit according to claim 1, wherein
the control circuit is further configured to (h) narrow the range of addresses that can be obtained as the first address by removing from the range the address having the largest value among the addresses in the range, and repeat the process from (b) to (h) except for (f) if the first address and the second address are the same address.

9. The random number generation circuit according to claim 1, further comprising:
a first circuit configured to generate the first random number; and
a second circuit configured to read the second value stored in the second storage area.

10. The random number generation circuit according to claim 9, wherein
the first circuit and the second circuit are configured to operate independently with respect to each other and in parallel.

11. A random number generation circuit comprising:
a memory circuit including a plurality of storage areas each designated by one of a plurality of addresses; and
a control circuit configured to:
divide the plurality of addresses into a first group and a second group;
store a plurality of values, all of which are different from each other, in a plurality of first storage areas, each designated by one of the addresses in the first group, and store the same values as stored in the plurality of first storage areas in a plurality of second storage areas, each designated by one of the addresses in the second group;
generate a first random number;
obtain a first address that is one of the plurality of addresses using the first random number;
when the first address belongs to the first group,
read a first value stored at a third storage area designated by the first address, and perform a first calculation on the first value to obtain a second value;
read a third value stored in a fourth storage area designated by a second address that is an address having the largest value among a first range of addresses from which the first address can be obtained;
write the third value to the third storage area after reading the first value therefrom; and
output the second value as one value of an output random number, and
when the first address belongs to the second group,
read a fourth value stored at a fifth storage area designated by the first address, and perform a second calculation on the fourth value to obtain a fifth value;
read a sixth value stored in a sixth storage area designated by a third address that is an address having the largest value among a second range of addresses from which the first address can be obtained;
write the sixth value to the fifth storage area after reading the fourth value therefrom; and
output the fifth value as one value of the output random number.

12. The random number generation circuit according to claim 11, wherein
when obtaining X random numbers, where X is an integer greater than or equal to 0, the control circuit:
divides the plurality of addresses into the first group and the second group each including Y addresses, where Y is equal to one half of X;
when the first address belongs to the first group,
sets a first variable to 0;
adds the value of the first variable to the first value in the first calculation; and
when the first address belongs to the second group,
sets the first variable to Y; and
adds the value of the first variable to the fourth value in the second calculation.

13. The random number generation circuit according to claim 11, wherein
when obtaining X random numbers, where X is an integer greater than or equal to 0, the control circuit:
divides the plurality of addresses into the first group and the second group each including Y addresses, where Y is equal to one half of X;
when the first address belongs to the first group,
sets a first variable to 0; and
doubles the first value and adds the value of the first variable to the doubled first value in the first calculation; and
when the first address belongs to the second group,
sets the first variable to 1; and
doubles the fourth value and adds the value of the first variable to the doubled fourth value in the second calculation.

14. The random number generation circuit according to claim 11, wherein
the memory circuit includes a first memory and a second memory,
the first memory includes the plurality of first storage areas, and
the second memory includes the plurality of second storage areas.

15. The random number generation circuit according to claim 11, wherein
the control circuit is configured to:
further divide the plurality of addresses into a third group and a fourth group;
store the same values as the values respectively stored in the plurality of first storage areas in a plurality of seventh storage areas respectively designated by the plurality of addresses of the third group;
store the same values as the values respectively stored in the plurality of first storage areas in a plurality of eighth storage areas respectively designated by the plurality of addresses of the fourth group;
when the first address belongs to the third group,
read a seventh value stored at a ninth storage area designated by the first address, and perform a third calculation on the seventh value to obtain an eighth value;
read a ninth value stored in a tenth storage area designated by a fourth address that is an address having the largest value among a third range of addresses from which the first address can be obtained;
write the ninth value to the ninth storage area after reading the seventh value therefrom; and
output the eighth value as one value of the output random number, and
when the first address belongs to the fourth group,
read a tenth value stored at an eleventh storage area designated by the first address, and perform a fourth calculation on the tenth value to obtain an eleventh value;
read a twelfth value stored in a twelfth storage area designated by a fifth address that is an address having the largest value among a fourth range of addresses from which the first address can be obtained;
write the twelfth value to the eleventh storage area after reading the tenth value therefrom; and
output the eleventh value as one value of the output random number.

16. The random number generation circuit according to claim 15, wherein
when obtaining X random numbers, where X is an integer greater than or equal to 0, the control circuit:
divides the plurality of addresses into the first group, the second group, the third group, and the fourth group, each including Z addresses, where Z is equal to one quarter of X;
when the first address belongs to the first group,
sets a first variable to 0; and
multiplies the first value by 4 and adds the value of the first variable to the multiplied first value in the first calculation;
when the first address belongs to the second group,
sets the first variable to 1; and
multiplies the fourth value by 4 and adds the value of the first variable to the multiplied fourth value in the second calculation,
when the first address belongs to the third group,
sets the first variable to 2; and
multiplies the seventh value by 4 and adds the value of the first variable to the multiplied seventh value in the third calculation, and
when the first address belongs to the fourth group,
sets the first variable to 3; and
multiplies the tenth value by 4 and adds the value of the first variable to the multiplied tenth value in the fourth calculation.

17. A memory system comprising:
a nonvolatile memory; and
a memory controller including the random number generation circuit according to claim 1 and configured to control the nonvolatile memory, wherein
the memory controller is configured to:
read data from the nonvolatile memory;
insert an error into the read data based on the output random number output from the random number generation circuit; and
perform error correction on the data in which the error has been inserted.

18. The memory system according to claim 17, wherein
the memory controller is configured to determine a position of the error to be inserted into the read data based on the output random number output from the random number generation circuit.

19. A memory system comprising:
a nonvolatile memory; and
a memory controller including the random number generation circuit according to claim 11 and configured to control the nonvolatile memory, wherein
the memory controller is configured to:
read data from the nonvolatile memory;
insert an error into the read data based on the output random number output from the random number generation circuit; and
perform error correction on the data in which the error has been inserted.

20. The memory system according to claim 19, wherein
the memory controller is configured to determine a position of the error to be inserted into the read data based on the output random number output from the random number generation circuit.
